(19) United States
(12) Patent Application Publication
(10) Pub. No.: US 2025/0259782 A1
(43) Pub. Date: Aug. 14, 2025

(54) INDUCTOR COMPONENT

(71) Applicant: Murata Manufacturing Co., Ltd., Kyoto-fu (JP)

(72) Inventors: Tsuyoshi TAKAMATSU, Nagaokakyo-shi (JP); Yoshimasa YOSHIOKA, Nagaokakyo-shi (JP); Hideki KAMO, Nagaokakyo-shi (JP)

(73) Assignee: Murata Manufacturing Co., Ltd., Kyoto-fu (JP)

(21) Appl. No.: 19/195,304

(22) Filed: Apr. 30, 2025

Related U.S. Application Data
(63) Continuation of application No. PCT/JP2023/030314, filed on Aug. 23, 2023.

(30) Foreign Application Priority Data
Nov. 2, 2022 (JP) 2022-176448

(51) Int. Cl. H01F 27/29; H01F 17/00

(52) U.S. Cl. CPC H01F 27/292; H01F 17/0013

(57) ABSTRACT

An inductor component includes an element body having first and second principal surfaces opposite to each other; a coil that is in the element body and is wound in a spiral shape along an axis; and first and second external electrodes that are on the element body and are electrically connected to the coil. The axis of the coil is parallel to the first principal surface. The coil includes first coil wirings which are on the first principal surface side with respect to the axis and are arranged along the axis on a plane parallel to the first principal surface, second coil wirings which are on the second principal surface side with respect to the axis and are arranged along the axis on a plane parallel to the second principal surface, and first penetration wirings which extend from the respective first coil wirings toward the respective second coil wirings.

### CROSS REFERENCE TO RELATED APPLICATION

This application claims benefit of priority to International Patent Application No. PCT/JP2023/030314, filed Aug. 23, 2023, and to Japanese Patent Application 2022-176448 filed Nov. 2, 2022, the entire content of each are incorporated herein by reference.

### BACKGROUND

### Technical Field

The present disclosure relates to an inductor component.

### Background Art

Conventionally, as an inductor component, there is an inductor component described in Japanese Patent No. 6652280. The inductor component includes an element body, a coil that is provided in the element body and is wound along an axial direction, and a first external electrode and a second external electrode that are provided on the element body and are electrically connected to the coil.

The coil has a plurality of coil patterns layered along an axis. The coil patterns adjacent to each other in the axial direction are connected via a conductive via. Each coil pattern includes a wiring portion extending in a direction orthogonal to the axis and a pad portion that is provided at an end portion of the wiring portion and is connected to the conductive via. A width of the pad portion is wider than a width of the wiring portion in order to improve the connectivity between the pad portion and the conductive via.

### SUMMARY

Incidentally, in the conventional inductor component, since the width of the pad portion is wider than the width of the wiring portion, a part of the pad portion is positioned on an inner side in a radial direction of the coil with respect to the wiring portion. Therefore, an inner diameter of the coil becomes small, and the efficiency of acquisition of inductance is not necessarily high.

In this regard, the present disclosure provides an inductor component capable of increasing the efficiency of acquisition of inductance.

Accordingly, one aspect of the present disclosure provides an inductor component comprising an element body having a first principal surface and a second principal surface opposite to each other; a coil that is provided in the element body and is wound in a spiral shape along an axis; and a first external electrode and a second external electrode that are provided on the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order. Also, on a cross section parallel to the first principal surface and including the axis, the first penetration wirings have respective inner circumferential edges facing the axis side and respective outer circumferential edges facing a side opposite to the axis, and the inner circumferential edges have a length longer than a length of the outer circumferential edges.

Here, the axis indicates an intersection line of a first plane passing through centers between the first coil wirings and the second coil wirings and a second plane passing through centers between the first penetration wirings and the second penetration wirings. The inner circumferential edges facing the axis side indicate regions on entire circumferential edges of the first penetration wirings which are projected on the axis, when the first penetration wirings are projected toward the axis in a direction orthogonal to the axis. The outer circumferential edges facing the side opposite to the axis indicate regions on the entire circumferential edges of the first penetration wirings that are projected on a virtual line, when the virtual line is defined to be parallel to the axis on the side opposite to the axis with respect to the first penetration wirings, and the first penetration wirings are projected toward the virtual line in a direction orthogonal to the axis. Regions on the entire circumferential edges of the first penetration wirings which are parallel to the direction orthogonal to the axis do not correspond to the inner circumferential edges and the outer circumferential edges. That “the external electrode is provided on the element body” specifically indicates that the external electrode is provided on an outer surface side of the element body. For example, this includes a case where the external electrode is provided immediately on an outer surface of the element body, a case where the external electrode is provided on an outer side of the element body via an additional member on the element body, and a case where the external electrode is provided on the outer surface of the external electrode in a state where a part of the external electrode is embedded in the element body.

According to the embodiment, since the coil includes the first coil wirings, the first penetration wirings, the second coil wirings, and the second penetration wirings, and each of the first coil wirings, each of the first penetration wirings, each of the second coil wirings, and each of the second penetration wirings form at least a part of the spiral shape by being connected in this order, it is possible to increase an inner diameter of the coil such that it is possible to increase the efficiency of acquisition of inductance. In addition, a Q value can be increased by increasing the efficiency of acquisition of inductance. Further, since the length of the inner circumferential edges of the first penetration wirings is longer than the length of the outer circumferential edges of the first penetration wirings, it is possible to increase a surface area of an inner surface of the coil such that an electrical resistance value at a high frequency is decreased, and a Q value at the high frequency is improved.

Another aspect of the present disclosure provides an inductor component comprising an element body having a first principal surface and a second principal surface opposite to each other; a coil that is provided in the element body and is wound in a spiral shape along an axis; and a first external electrode and a second external electrode that are provided on the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order. Also, when a bisector of an angle formed by each of the first coil wirings and each of the second coil wirings connected to a reference first penetration wiring that is one of the first penetration wirings is defined when viewed in a direction orthogonal to the first principal surface, on a cross section parallel to the first principal surface and including the axis, the reference first penetration wiring has an inner circumferential edge facing the bisector side and an outer circumferential edge facing a side opposite to the bisector, and the inner circumferential edge has a length longer than a length of the outer circumferential edge.

Here, the angle formed by each of the first coil wirings and each of the second coil wirings is an angle between a center line of a width of each of the first coil wirings and a center line of a width of each of the second coil wirings when viewed in the direction orthogonal to the first principal surface. The inner circumferential edge facing the bisector side indicates a region on an entire circumferential edge of the reference first penetration wiring which is projected on an orthogonal line, when the reference first penetration wiring is projected toward the orthogonal line orthogonal to the bisector in a direction parallel to the bisector. The outer circumferential edge facing the side opposite to the bisector indicates a region on the entire circumferential edge of the reference first penetration wiring that is projected on a virtual line, when the virtual line is defined to be parallel to the orthogonal line on a side opposite to the orthogonal line with respect to the reference first penetration wiring, and the reference first penetration wiring is projected toward the virtual line in a direction parallel to the bisector. A region on the entire circumferential edge of the reference first penetration wiring on which a direction orthogonal to the circumferential edge is opposite to a direction parallel to the bisector does not correspond to the inner circumferential edge and the outer circumferential edge.

According to the embodiment, since the coil includes the first coil wirings, the first penetration wirings, the second coil wirings, and the second penetration wirings, and each of the first coil wirings, each of the first penetration wirings, each of the second coil wirings, and each of the second penetration wirings form at least a part of the spiral shape by being connected in this order, it is possible to increase an inner diameter of the coil such that it is possible to increase the efficiency of acquisition of inductance. In addition, a Q value can be increased by increasing the efficiency of acquisition of inductance. Further, since the length of the inner circumferential edges of the reference first penetration wirings is longer than the length of the outer circumferential edges of the reference first penetration wirings, it is possible to increase a surface area of an inner surface of the coil such that the electrical resistance value at the high frequency is decreased, and the Q value at the high frequency is improved.

Still another aspect of the present disclosure provides an inductor component comprising an element body having a first principal surface and a second principal surface opposite to each other; a coil that is provided in the element body and is wound in a spiral shape along an axis; and a first external electrode and a second external electrode that are provided on the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order. Also, on a cross section parallel to the first principal surface and including the axis, the first penetration wirings have respective inner circumferential edges parallel to the axis and facing the axis side and respective outer circumferential edges parallel to the axis and facing a side opposite to the axis, and the inner circumferential edges have a length longer than a length of the outer circumferential edge.

According to the embodiment, since the coil includes the first coil wirings, the first penetration wirings, the second coil wirings, and the second penetration wirings, and each of the first coil wirings, each of the first penetration wirings, each of the second coil wirings, and each of the second penetration wirings form at least a part of the spiral shape by being connected in this order, it is possible to increase an inner diameter of the coil such that it is possible to increase the efficiency of acquisition of inductance. In addition, a Q value can be increased by increasing the efficiency of acquisition of inductance. Further, since the length of the inner circumferential edges of the first penetration wirings is longer than the length of the outer circumferential edges of the first penetration wirings, it is possible to increase the surface area of the inner surface of the coil such that the electrical resistance value at the high frequency is decreased, and the Q value at the high frequency is improved.

Still another aspect of the present disclosure provides an inductor component comprising an element body having a first principal surface and a second principal surface opposite to each other; a coil that is provided in the element body and is wound in a spiral shape along an axis; and a first external electrode and a second external electrode that are provided on the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order. Also, when a bisector of an angle formed by each of the first coil wirings and each of the second coil wirings connected to a reference first penetration wiring that is one of the first penetration wirings is defined when viewed in a direction orthogonal to the first principal surface, on a cross section parallel to the first principal surface and including the axis, the reference first penetration wiring has an inner circumferential edge parallel to a direction orthogonal to the bisector and facing the bisector side and an outer circumferential edge parallel to the direction orthogonal to the bisector and facing a side opposite to the bisector, and the inner circumferential edge has a length longer than a length of the outer circumferential edge.

Here, the angle formed by each of the first coil wirings and each of the second coil wirings is the angle between the center line of the width of each of the first coil wirings and the center line of the width of each of the second coil wirings when viewed in the direction orthogonal to the first principal surface.

According to the embodiment, since the coil includes the first coil wirings, the first penetration wirings, the second coil wirings, and the second penetration wirings, and each of the first coil wirings, each of the first penetration wirings, each of the second coil wirings, and each of the second penetration wirings form at least a part of the spiral shape by being connected in this order, it is possible to increase an inner diameter of the coil such that it is possible to increase the efficiency of acquisition of inductance. In addition, a Q value can be increased by increasing the efficiency of acquisition of inductance. Further, since the length of the inner circumferential edges of the reference first penetration wirings is longer than the length of the outer circumferential edges of the reference first penetration wirings, it is possible to increase the surface area of the inner surface of the coil such that the electrical resistance value at the high frequency is decreased, and the Q value at the high frequency is improved.

Preferably, in the embodiment of the inductor component, the element body contains SiO₂.

According to the embodiment, it is possible to impart insulation properties and stiffness to the element body.

Preferably, in an embodiment of the inductor component, the inner circumferential edges of the first penetration wirings have respective convex curved portions.

According to the embodiment, it is possible to distribute stress applied to the curved portions of the inner circumferential edges of the first penetration wirings.

Preferably, in the embodiment of the inductor component, the plurality of first penetration wirings include two of the first penetration wirings in which orientations of the curved portions of the inner circumferential edges are different from each other.

Here, an orientation of the curved portions indicates a direction in which a midpoint of each curved portion and a center line of each first penetration wiring are connected.

According to the embodiment, it is possible to change the orientation of the curved portions of the first penetration wirings depending on arrangement of the first coil wirings and the second coil wirings.

Preferably, in the embodiment of the inductor component, the inner circumferential edges of the first penetration wirings have a length which is 1.5 times or more a length of the outer circumferential edges of the first penetration wirings.

According to the embodiment, it is possible to increase the length of the inner circumferential edges of the first penetration wirings, and it is possible to further decrease an electrical resistance value at a high frequency.

Preferably, in the embodiment of the inductor component, when viewed in the direction orthogonal to the first principal surface, a first end portion of each of the first coil wirings is connected to a first end portion of each of the first penetration wirings, and an outer shape of the coil of the first end portion of each of the first coil wirings conforms to an outer shape of the coil of the first end portion of each of the first penetration wirings.

According to the embodiment, the shape of the first end portion of each of the first coil wirings can be made to correspond to the shape of the first end portion of each of the first penetration wirings, and it is possible to decrease the DC electrical resistance of a connection part between each of the first coil wirings and each of the first penetration wirings.

Preferably, in the embodiment of the inductor component, when viewed in the direction orthogonal to the first principal surface, an angle formed by each of the first coil wirings and each of the second coil wirings connected to the same first penetration wiring is 5° or larger and 45° or smaller (i.e., from 5° to) 45°.

According to the embodiment, since the coils are densely wound, it is possible to improve the inductance.

Preferably, in the embodiment of the inductor component, on a cross section orthogonal to an extending direction of the first coil wirings, upper surfaces of the first coil wirings positioned on a side opposite to the axis have a convex shape protruding upward on a side opposite to the axis.

According to the embodiment, it is possible to increase a distance between the upper surfaces of two first coil wirings adjacent to each other in the axial direction, and it is possible to decrease parasitic capacitance between the adjacent first coil wirings such that it is possible to increase the self-resonant frequency of the inductor component.

Preferably, in the embodiment of the inductor component, the first external electrode is disposed on the first coil wirings, and the upper surfaces of the first coil wirings face the first external electrode.

According to the embodiment, it is possible to increase a distance between upper surfaces of the first external electrode and each of the first coil wirings, and it is possible to decrease parasitic capacitance between the first external electrode and each of the first coil wirings such that it is possible to increase the self-resonant frequency of the inductor component.

Preferably, in the embodiment of the inductor component, when viewed in a direction parallel to the axis, the first penetration wirings and the second penetration wirings are not parallel to each other.

According to the embodiment, it is possible to increase a distance between each of the first penetration wirings and each of the second penetration wirings, and it is possible to increase the inner diameter of the coil such that it is possible to improve the Q value.

Preferably, in the embodiment of the inductor component, the element body contains SiO₂, and the first penetration wirings contain SiO₂.

According to the embodiment, the first penetration wirings can have a linear expansion coefficient equal to a linear expansion coefficient of the element body, and it is possible to reduce cracks between the first penetration wirings and the element body.

Preferably, in the embodiment of the inductor component, each of the first penetration wirings has a void portion or a resin portion.

According to the embodiment, stress due to a difference in linear expansion coefficient between the first penetration wirings and the element body can be absorbed by the void portion or the resin portion, and this enables the stress to be alleviated.

Preferably, in the embodiment of the inductor component, each of the first penetration wirings includes a conductive layer positioned on an outer circumferential side when viewed in an extending direction of the first penetration wirings, and a non-conductive layer positioned inside the conductive layer.

According to the embodiment, since a current mainly flows in a surface of the first penetration wirings due to a skin effect in the case of use in a high frequency band, the Q value is not decreased by providing the conductive layer on the outer circumferential side. In addition, by providing the non-conductive layer inside, stress can be alleviated, and manufacturing costs can be reduced by using no conductor.

Preferably, in the embodiment of the inductor component, a length of the coil in an axial direction is shorter than an inner diameter of the coil.

According to the embodiment, since the coil length is short and the inner diameter of the coil is large, it is possible to improve the Q value.

Preferably, in the embodiment of the inductor component, the first penetration wirings extend in the direction orthogonal to the first principal surface, and a cross-sectional area of at least one of both end portions of each of the first penetration wirings in the extending direction is larger than a cross-sectional area of a central portion of each of the first penetration wirings in the extending direction.

According to the embodiment, it is possible to increase the cross-sectional area of the end portion of the first penetration wiring such that connectivity between the first penetration wiring and at least one of the first coil wiring and the second coil wiring can be improved. In addition, when a hole portion is formed in the element body, the hole portion is filled with a conductive material by fill plating or the like, and the first penetration wiring is formed in the hole portion of the element body, it is easy to fill the hole portion on an opening side with the conductive material. Since the cross-sectional area of the end portion of the first penetration wiring is large, and the cross-sectional area of the central portion of the first penetration wiring is small, the first penetration wiring is easily formed.

Preferably, in the embodiment of the inductor component, when viewed in the direction orthogonal to the first principal surface, the first external electrode and the second external electrode are positioned on an inner side with respect to an outer surface of the element body.

According to the configuration, since the first external electrode and the second external electrode are not in contact with the outer surfaces of the element body, loads applied to the first external electrode and the second external electrode can be decreased, and deformation and peeling of the first external electrode and the second external electrode can be reduced, when division into individual inductor components is performed. Therefore, even if the inductor component has a small size, it is possible to prevent the first external electrode and the second external electrode from being deformed or peeled off.

Preferably, the embodiment of the inductor component further comprises an organic insulating body provided on the first principal surface. The element body is an inorganic insulating body, and the organic insulating body is positioned on an inner side with respect to an outer surface of the inorganic insulating body when viewed in the direction orthogonal to the first principal surface.

According to the embodiment, since the organic insulating body is provided, the organic insulating body easily imparts flowability, the organic insulating body easily fills a space between the first coil wirings adjacent to each other and enables insulating properties to be improved, in a case where the first coil wirings are covered with the organic insulating body. In addition, since the organic insulating body is not in contact with the outer surface of the inorganic insulating body, it is possible to decrease a load applied to the organic insulating body and reduce deformation and peeling of the organic insulating body when division into individual inductor components is performed.

According to the inductor component which is the one aspect of the present disclosure, it is possible to increase the efficiency of acquisition of inductance.

### BRIEF DESCRIPTION OF THE DRAWINGS

FIG. 1 is a schematic perspective view of an inductor component from a bottom surface side according to a first embodiment.

FIG. 2 is a cross-sectional view taken along line II-II in FIG. 1.

FIG. 3 is a cross-sectional view taken along line III-III in FIG. 1.

FIG. 4 is an XY cross-sectional view of a first penetration wiring and a second penetration wiring.

FIG. 5 is an enlarged view of a part of FIG. 1.

FIG. 6A is a schematic cross-sectional view illustrating a method for manufacturing an inductor component.

FIG. 6B is a schematic cross-sectional view illustrating the method for manufacturing an inductor component.

FIG. 6C is a schematic cross-sectional view illustrating the method for manufacturing an inductor component.

FIG. 6D is a schematic cross-sectional view illustrating the method for manufacturing an inductor component.

FIG. 6E is a schematic cross-sectional view illustrating the method for manufacturing an inductor component.

FIG. 6F is a schematic cross-sectional view illustrating the method for manufacturing an inductor component.

FIG. 6G is a schematic cross-sectional view illustrating the method for manufacturing an inductor component.

FIG. 6H is a schematic cross-sectional view illustrating the method for manufacturing an inductor component.

FIG. 6I is a schematic cross-sectional view illustrating the method for manufacturing an inductor component.

FIG. 6J is a schematic cross-sectional view illustrating the method for manufacturing an inductor component.

FIG. 6K is a schematic cross-sectional view illustrating the method for manufacturing an inductor component.

FIG. 6L is a schematic cross-sectional view illustrating the method for manufacturing an inductor component.

FIG. 6M is a schematic cross-sectional view illustrating the method for manufacturing an inductor component.

FIG. 7A is a cross-sectional view showing a first modification example of the inductor component.

FIG. 7B is a cross-sectional view showing a second modification example of the inductor component.

FIG. 7C is a cross-sectional view showing a third modification example of the inductor component.

FIG. 7D is a cross-sectional view showing a fourth modification example of the inductor component.

FIG. 8 is a schematic bottom view of an inductor component from a bottom surface side according to a second embodiment.

FIG. 9 is a cross-sectional view taken along line IX-IX in FIG. 8.

FIG. 10 is a schematic bottom view of a coil from the bottom surface side.

FIG. 11 is an XY cross-sectional view of a first penetration wiring and a second penetration wiring.

FIG. 12A is a schematic cross-sectional view illustrating a method for manufacturing an inductor component.

FIG. 12B is a schematic cross-sectional view illustrating the method for manufacturing an inductor component.

FIG. 12C is a schematic cross-sectional view illustrating the method for manufacturing an inductor component.

FIG. 12D is a schematic cross-sectional view illustrating the method for manufacturing an inductor component.

FIG. 12E is a schematic cross-sectional view illustrating the method for manufacturing an inductor component.

FIG. 12F is a schematic cross-sectional view illustrating the method for manufacturing an inductor component.

FIG. 12G is a schematic cross-sectional view illustrating the method for manufacturing an inductor component.

FIG. 12H is a schematic cross-sectional view illustrating the method for manufacturing an inductor component;

FIG. 13A is a cross-sectional view showing a first modification example of the inductor component;

FIG. 13B is a cross-sectional view showing a second modification example of the inductor component;

FIG. 13C is a cross-sectional view showing a third modification example of the inductor component;

FIG. 14 is an XY cross-sectional view showing a first penetration wiring of an inductor component according to a third embodiment; and

FIG. 15 is an XY cross-sectional view showing a first penetration wiring of an inductor component according to a fourth embodiment.

### DETAILED DESCRIPTION

Hereinafter, an inductor component which is the one aspect of the present disclosure will be described in detail with reference to embodiments shown in the drawings. Note that the drawings include some schematic drawings, and may not reflect actual dimensions and ratios.

### First Embodiment

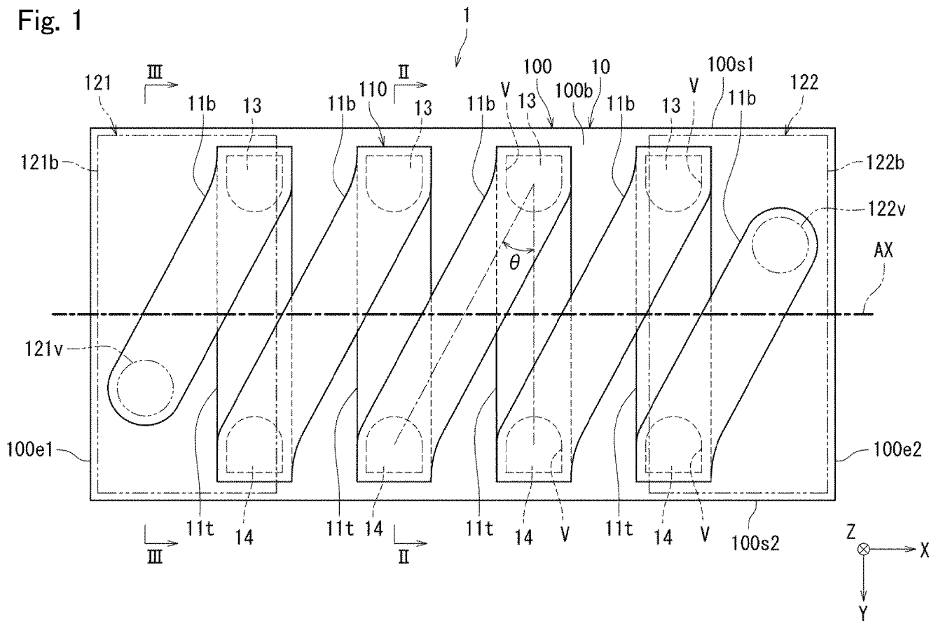

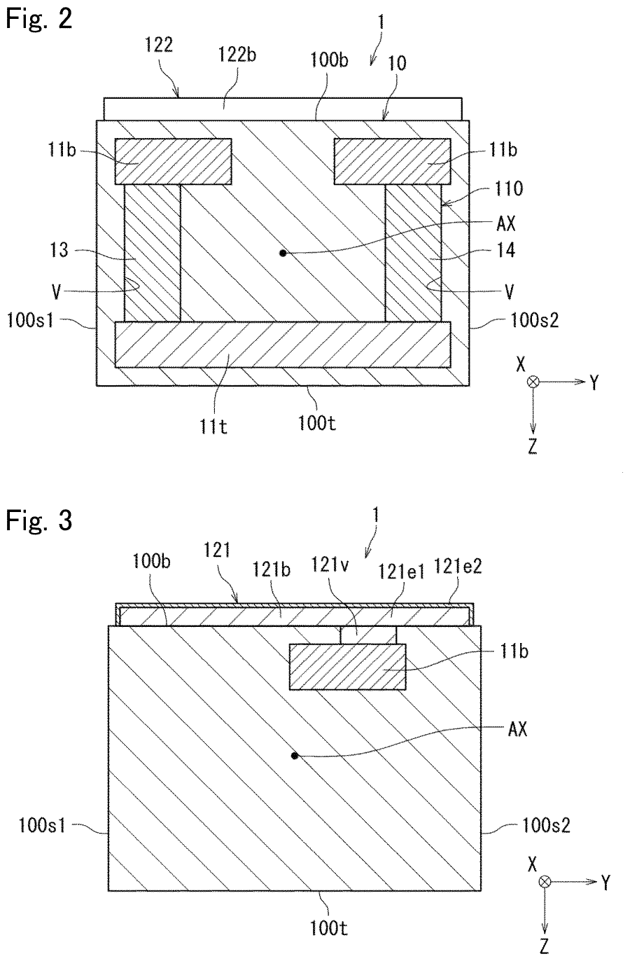

An inductor component 1 according to the first embodiment will be described below. FIG. 1 shows a schematic bottom view of the inductor component 1 from a bottom surface side thereof. FIG. 2 is a cross-sectional view taken along line II-II in FIG. 1. FIG. 3 is a cross-sectional view taken along line III-III in FIG. 1. Note that, in FIG. 1, an external electrode is drawn by a two-dot chain line for convenience. In addition, in FIG. 1, an element body 10 is drawn transparently so that a structure thereof can be easily understood, but may be translucent or opaque.

### 1. General Configuration

A general configuration of the inductor component 1 will be described. The inductor component 1 is, for example, a surface mount inductor component that is used in a high-frequency signal transmission circuit. As shown in FIGS. 1, 2, and 3, the inductor component 1 includes the element body 10, a coil 110 that is provided in the element body 10 and is wound in a spiral shape along an axis AX, and a first external electrode 121 and a second external electrode 122 that are provided on the element body 10 and are electrically connected to the coil 110.

The element body 10 has a length, a width, and a height. The element body 10 has a first end surface 100e1 and a second end surface 100e2 on both end sides in a length direction, a first side surface 100s1 and a second side surface 100s2 on both end sides in a width direction, and a bottom surface 100b and a top surface 100t on both end sides in a height direction. That is, outer surfaces 100 of the element body 10 include the first end surface 100e1 and the second end surface 100e2, the first side surface 100s1 and the second side surface 100s2, and the bottom surface 100b and the top surface 100t. The bottom surface 100b corresponds to an example of a “first principal surface” described in CLAIMS, and the top surface 100t corresponds to an example of a “second principal surface” described in CLAIMS.

As shown in the drawings, hereinafter, for convenience of description, a direction that is the length direction (longitudinal direction) of the element body 10 and is from the first end surface 100e1 toward the second end surface 100e2 is referred to as an X direction. In addition, a direction that is the width direction of the element body 10 and is from the first side surface 100s1 toward the second side surface 100s2 is referred to as a Y direction. In addition, a direction that is the height direction of the element body 10 and is from the bottom surface 100b toward the top surface 100t is referred to as a Z direction. The X direction, the Y direction, and the Z direction are directions orthogonal to each other and form a right-handed system when arranged in an order of X, Y, and Z.

In this specification, the “outer surfaces 100 of the element body” including the first end surface 100e1, the second end surface 100e2, the first side surface 100s1, the second side surface 100s2, the bottom surface 100b, and the top surface 100t of the element body 10 do not simply mean surfaces of the element body 10 toward the outer circumferential sides of the element body 10, but are surfaces serving as a boundary between an outside and an inside of the element body 10. In addition, “above the outer surfaces 100 of the element body 10” does not indicate an absolute direction such as a vertical upward direction defined in the direction of gravity, but indicates a direction toward the outside with the outer surfaces 100 as a reference, of the outside and inside with the outer surfaces 100 as the boundary therebetween. Hence, “above the outer surfaces 100” indicates a relative direction determined depending on an orientation of the outer surfaces 100. In addition, “above” with respect to a certain element means not only above from the corresponding element, that is, an upper position via another object on the corresponding element or an upper position apart from the corresponding element at an interval, but also a position immediately on the corresponding element to be in contact with the corresponding element.

The axis AX of the coil 110 is disposed parallel to the bottom surface 100b. The coil 110 includes a plurality of bottom surface wirings 11b which are provided on the bottom surface 100b side with respect to the axis AX and are arranged along the axis AX on a plane parallel to the bottom surface 100b, a plurality of top surface wirings 11t which are provided on the top surface 100t side with respect to the axis AX and are arranged along the axis AX on a plane parallel to the top surface 100t, a plurality of first penetration wirings 13 which extend from the respective bottom surface wirings 11b toward the respective top surface wirings 11t, and are arranged along the axis AX, and a plurality of second penetration wirings 14 which extend from the respective bottom surface wirings 11b toward the respective top surface wirings 11t, are provided on a side opposite to the respective first penetration wirings 13 with respect to the axis AX, and are arranged along the axis AX. Each of the bottom surface wirings 11b, each of the first penetration wirings 13, each of the top surface wirings 11t, and each of the second penetration wirings 14 form at least a part of a spiral shape by being connected in this order.

The bottom surface wiring 11b corresponds to an example of a “first coil wiring” described in CLAIMS, and the top surface wiring 11t corresponds to an example of a “second coil wiring” described in CLAIMS. The axis AX indicates an intersection line of a first plane passing through centers between the bottom surface wirings 11b and the top surface wirings 11t and a second plane passing through centers between the first penetration wirings 13 and the second penetration wirings 14. That is, the axis AX is a straight line passing through a center of an inner diameter portion of the coil 110. The axis AX of the coil 110 does not have a dimension in a direction orthogonal to the axis AX.

According to the configuration described above, since the coil 110 includes the bottom surface wirings 11b, the first penetration wirings 13, the top surface wirings 11t, and the second penetration wirings 14, and each of the bottom surface wirings 11b, each of the first penetration wirings 13, each of the top surface wirings 11t, and each of the second penetration wirings 14 form at least a part of the spiral shape by being connected in this order, it is possible to increase an inner diameter of the coil 110 such that it is possible to increase the efficiency of acquisition of inductance. In addition, a Q value can be increased by increasing the efficiency of acquisition of inductance.

To be more specific, since pad portions of a conventional inductor component or the bottom surface wirings 11b and the top surface wirings 11t of the present embodiment are “reception portions” of wirings (conductive vias of the conventional inductor component or the first penetration wirings 13 and the second penetration wirings 14 of the present embodiment) which penetrate an element body, the pad portions and the bottom and top surface wirings have a shape expanding perpendicularly to a direction in which to penetrate the element body. Here, in a configuration of the conventional inductor component, since the conductive vias extend in a direction parallel to an axis of a coil, the pad portions are expanded in a direction perpendicular to the axis of the coil and are likely to have a structure in which magnetic flux generated in an axial direction of the coil is blocked.

On the other hand, in the present embodiment, since the first penetration wiring 13 and the second penetration wiring 14 extend in a direction perpendicular to the axis AX of the coil 110, the bottom surface wiring 11b and the top surface wiring 11t are expanded in a direction parallel to the axis AX of the coil 110. Accordingly, it is difficult for the bottom surface wiring 11b and the top surface wiring 11t to have a structure in which magnetic flux generated in an axis AX direction is blocked. That is, according to the present embodiment, it is possible to have the structure in which it is difficult to block the magnetic flux such that it is possible to improve the efficiency of acquisition of inductance and the Q value.

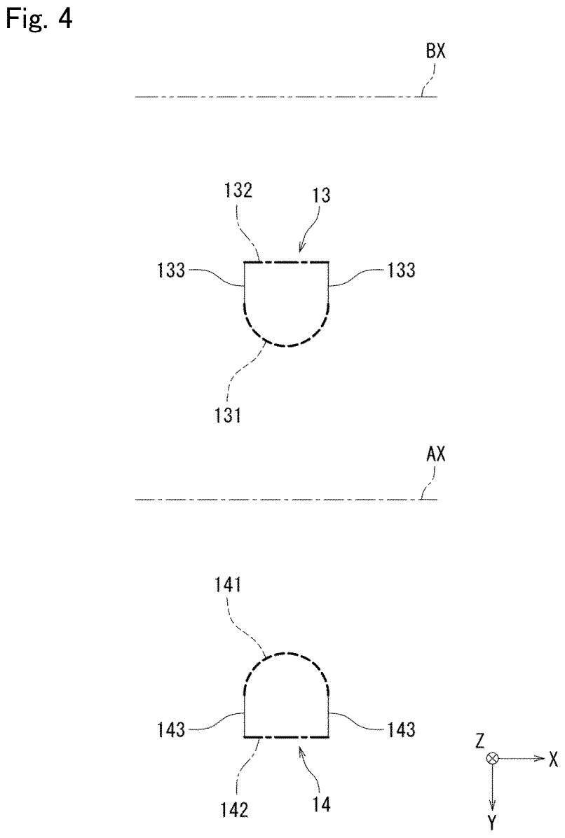

FIG. 4 is an XY cross-sectional view of the first penetration wiring 13 and the second penetration wiring 14. As shown in FIG. 4, on a cross section parallel to the bottom surface 100b and including the axis AX, the first penetration wiring 13 has an inner circumferential edge 131 facing the axis AX side, an outer circumferential edge 132 facing a side opposite to the axis AX, and a side edge 133 parallel to a direction orthogonal to the axis AX. A length of the inner circumferential edge 131 is longer than a length of the outer circumferential edge 132. In FIG. 4, for convenience, the inner circumferential edge 131 is represented by a dotted line, the outer circumferential edge 132 is represented by a chain line, and the side edge 133 is represented by a solid line.

The inner circumferential edge 131 is a region on an entire circumferential edge of the first penetration wiring 13 which is projected on the axis AX, when the first penetration wiring 13 is projected toward the axis AX in a direction orthogonal to the axis AX. The outer circumferential edge 132 is a region on the entire circumferential edge of the first penetration wiring 13 that is projected on a virtual line BX, when the virtual line BX is defined to be parallel to the axis AX on the side opposite to the axis AX with respect to the first penetration wiring 13, and the first penetration wiring is projected toward the virtual line BX in a direction orthogonal to the axis AX.

According to the configuration described above, since a length of the inner circumferential edge 131 is longer than a length of the outer circumferential edge 132, it is possible to increase a surface area of an inner surface of the first penetration wiring 13. Consequently, it is possible to increase a surface area of an inner surface of the coil 110 such that an electrical resistance value at a high frequency is decreased, and the Q value at the high frequency is improved. To be more specific, in a case where a high frequency signal passes through the coil 110, currents concentrate in the vicinity of a surface of the coil 110 due to a skin effect. However, in the present embodiment, since the inner circumferential edge 131 of the first penetration wiring 13 on which the high frequency signal concentrates is relatively long, the electrical resistance value decreases, and the Q value at a high frequency is improved.

In addition, the second penetration wiring 14 has the same configuration as that of the first penetration wiring 13 and has the same operation and effects as those of the above-described first penetration wiring 13. To be more specific, the second penetration wiring 14 has an inner circumferential edge 141 facing the axis AX side, an outer circumferential edge 142 facing the side opposite to the axis AX, and a side edge 143 parallel to the direction orthogonal to the axis AX. A length of the inner circumferential edge 141 is longer than a length of the outer circumferential edge 142. Consequently, it is possible to increase a surface area of an inner surface of the second penetration wiring 14 such that it is possible to further increase the surface area of the inner surface of the coil 110 such that the electrical resistance value at a high frequency is further decreased, and the Q value at the high frequency is further improved.

Note that, in the first penetration wiring 13, the length of the inner circumferential edge 131 may be longer than the length of the outer circumferential edge 132, and in the second penetration wiring 14, the length of the inner circumferential edge 141 may be shorter than or equal to the length of the outer circumferential edge 142.

### 2. Configurations of Respective Units

### (Inductor Component 1)

A volume of the inductor component 1 is 0.08 mm³ or smaller, and a size of a long side of the inductor component 1 is 0.65 mm or smaller. The size of the long side of the inductor component 1 indicates the largest value of a length, a width, and a height of the inductor component 1, and in this embodiment, indicates the length in the X direction. According to the configuration described above, since the volume of the inductor component 1 is small and the long side of the inductor component 1 is short, a weight of the inductor component 1 is reduced. Therefore, even if the external electrodes 121 and 122 are small, necessary mounting strength can be obtained. In addition, a thickness of the inductor component 1 is preferably 0.2 mm or smaller. This enables a thin inductor component 1 to be obtained.

To be more specific, the size (length (X direction)× width (Y direction)× height (Z direction)) of the inductor component 1 is 0.6 mm×0.3 mm×0.3 mm, 0.4 mm×0.2 mm×0.2 mm, 0.25 mm×0.125 mm×0.120 mm, or the like. In addition, the width and the height may not be equal, and may be, for example, 0.4 mm×0.2 mm×0.3 mm.

### (Element Body 10)

The element body 10 contains SiO₂. This enables insulation properties and stiffness to be imparted to the element body 10. The element body 10 is made of, for example, a glass sintered body. The glass sintered body may contain alumina, and the strength of the element body can be further increased.

The glass sintered body is formed by, for example, layering insulating layers containing a plurality of types of glass. A layering direction of the plurality of insulating layers is the Z direction. That is, the insulating layer has a layer shape having a principal surface expanding on an X-Y plane. Note that, in the element body 10, an interface between the plurality of insulating layers may not be distinct due to firing or the like.

Note that the element body 10 may include, for example, a glass substrate. The glass substrate may be a single-layer glass substrate, and since most of the element body is made of glass, it is possible to reduce a loss such as an eddy current loss at a high frequency.

### (Coil 110)

The coil 110 includes the plurality of bottom surface wirings 11b, the plurality of top surface wirings 11t, the plurality of first penetration wirings 13, and the plurality of second penetration wirings 14. The bottom surface wirings 11b, the first penetration wirings 13, the top surface wirings 11t, and the second penetration wirings 14 are connected in this order, respectively, to constitute at least a part of the coil 110 wound in the axis AX direction.

According to the configuration described above, since the coil 110 is a so-called helical coil 110, in a cross section orthogonal to the axis AX, it is possible to reduce a region where the bottom surface wiring 11b, the top surface wiring 11t, the first penetration wiring 13, and the second penetration wiring 14 are laid out parallel to each other in a winding direction of the coil 110, and it is possible to reduce stray capacitance in the coil 110.

Here, the helical shape indicates a shape in which the number of turns of the entire coil is more than one turn, and the number of turns of the coil in the cross section orthogonal to the axis is less than one turn. One or more turns indicate a state in which the wirings of the coil have, on the cross section orthogonal to the axis, parts that are adjacent to each other in a radial direction and are laid out parallel to each other in the winding direction when viewed in an axial direction, and less than one turn indicates a state in which the wirings of the coil does not have, on the cross section orthogonal to the axis, parts that are adjacent to each other in the radial direction and are laid out parallel to each other in the winding direction when viewed in the axial direction.

The bottom surface wirings 11b extend only in one direction. To be more specific, the bottom surface wirings 11b slightly tilt in the X direction and extend in the Y direction. The plurality of bottom surface wirings 11b are arranged parallel to each other in the X direction. Here, in a photolithography process, when deformed illumination such as annular illumination or dipole illumination is used, pattern resolution in a specific direction can be enhanced to form a finer pattern. According to the configuration described above, since the bottom surface wirings 11b extend only in one direction, it is possible to form the fine bottom surface wirings 11b and reduce the size of the inductor component 1 by using, for example, modified illumination in the photolithography process.

The top surface wirings 11t extend only in one direction. To be more specific, the top surface wirings 11t have a shape extending in the Y direction. The plurality of top surface wirings 11t are arranged parallel to each other in the X direction. According to the configuration described above, since the top surface wirings 11t extend only in one direction, it is possible to form the fine narrow top surface wirings 11t and reduce the size of the inductor component 1 by using, for example, modified illumination in the photolithography process.

The bottom surface wirings 11b and the top surface wirings 11t are made of a good conductor material such as copper, silver, gold, or an alloy thereof. The bottom surface wirings 11b and the top surface wirings 11t may be a metal film formed by plating, vapor deposition, sputtering, or the like, or may be a metal sintered body obtained by applying and sintering a conductor paste. In addition, the bottom surface wirings 11b and the top surface wirings 11t may have a multilayer structure in which a plurality of metal layers are layered. The bottom surface wirings 11b and the top surface wirings 11t have a thickness of preferably 5 μm or more and 50 μm or less (i.e., from 5 μm to 50 μm).

The first penetration wirings 13 are disposed in through-holes V of the element body 10 on the first side surface 100s1 side with respect to the axis AX, and the second penetration wirings 14 are disposed in the other through-holes V of the element body 10 on the second side surface 100s2 side with respect to the axis AX. Each of the first penetration wirings 13 and the second penetration wirings 14 extends in a direction orthogonal to the bottom surface 100b and the top surface 100t. This enables lengths of the first penetration wirings 13 and the second penetration wirings 14 to be shortened, thus enabling the direct current resistance (Rdc) to be reduced. The plurality of first penetration wirings 13 and the plurality of second penetration wirings 14 are all arranged parallel to each other in the X direction.

Preferably, the first penetration wirings 13 contain SiO₂. This enables a linear expansion coefficient of the first penetration wiring 13 to be equal to a linear expansion coefficient of the element body 10 in a case where the element body 10 contains SiO₂, thus enabling cracks between the first penetration wirings 13 and the element body 10 to be reduced. The first penetration wiring 13 is made of, for example, a conductive paste. A conductive material is Ag, Cu, or the like. Similarly, the second penetration wirings 14 preferably contain SiO₂.

Preferably, the inner circumferential edge 131 of the first penetration wiring 13 has a convex curved portion. Consequently, it is possible to distribute stress applied to the curved portion of the inner circumferential edge 131 of the first penetration wiring 13. The entire inner circumferential edge 131 is the curved portion; however, a part of the inner circumferential edge 131 may be a curved portion. The outer circumferential edge 132 of the first penetration wiring 13 is a straight line parallel to the axis AX, but may have a convex curved portion, and it is possible to distribute stress applied to the curved portion of the outer circumferential edge 132 of the first penetration wiring 13. The side edge 133 of the first penetration wiring 13 is a straight line orthogonal to the axis AX.

Similarly, the inner circumferential edge 141 of the second penetration wiring 14 preferably has a convex curved portion. Consequently, it is possible to distribute stress applied to the curved portion of the inner circumferential edge 141 of the second penetration wiring 14. The outer circumferential edge 142 of the second penetration wiring 14 is a straight line parallel to the axis AX. The side edge 143 of the second penetration wiring 14 is a straight line orthogonal to the axis AX.

Preferably, the length of the inner circumferential edge 131 of the first penetration wiring 13 is 1.5 times or more the length of the outer circumferential edge 132 of the first penetration wiring 13. Consequently, it is possible to increase the length of the inner circumferential edge 131 of the first penetration wiring 13, and it is possible to further decrease an electrical resistance value at a high frequency. That is, since a current flows spirally on an inner diameter side of the coil 110, the electrical resistance decreases as the length of the inner circumferential edge 131 increases. For example, the length of the inner circumferential edge 131 is approximately 47 μm, and that of the outer circumferential edge 132 is approximately 30 μm. Regarding measurement of the lengths, WinRooF 2018 manufactured by MITANI CORPORATION is used, and it is possible to obtain a length of a circumferential edge (an inner circumferential edge and an outer circumferential edge) of a penetration wiring from an image diagram of a cross section. Note that, in the measurement of the inner circumferential edge and the outer circumferential edge, positions of both the inner circumferential edge and the outer circumferential edge to be measured may be designated. Note that a cross section to be measured is a cross section at a center of the first penetration wiring 13 in the extending direction.

Similarly, the length of the inner circumferential edge 141 of the second penetration wiring 14 is preferably 1.5 times or more the length of the outer circumferential edge 142 of the second penetration wiring 14. Consequently, it is possible to increase the length of the inner circumferential edge 141 of the second penetration wiring 14, and it is possible to further decrease an electrical resistance value at a high frequency.

Preferably, orientations of the curved portions of the inner circumferential edges 131 of all the first penetration wirings 13 are the same. The orientations of the curved portions are directions in which a midpoint of each curved portion and a center line of each first penetration wiring 13 are connected. The center line of the first penetration wiring 13 is a line passing through the center of gravity of the first penetration wiring 13 on a cross section orthogonal to an extending direction of the first penetration wiring 13. Here, since the entire inner circumferential edge 131 is a curved portion, an orientation of the curved portion is a direction in which a midpoint of the inner circumferential edge 131 and a center line of the first penetration wiring 13 are connected. The orientation of the curved portion is a direction orthogonal to the axis AX. Note that, in the two first penetration wirings 13, an orientation of the curved portion of the inner circumferential edge 131 of one first penetration wiring 13 may be different from an orientation of the curved portion of the inner circumferential edge 131 of the other first penetration wiring 13. Consequently, it is possible to change the orientation of the curved portion of the first penetration wiring 13 depending on arrangement of the bottom surface wirings 11b and the top surface wirings 11t.

Similarly, the curved portions of the inner circumferential edges 141 of all the second penetration wirings 14 have preferably the same orientation. Note that, in the two second penetration wirings 14, an orientation of the curved portion of the inner circumferential edge 141 of one second penetration wiring 14 may be different from an orientation of the curved portion of the inner circumferential edge 141 of the other second penetration wiring 14.

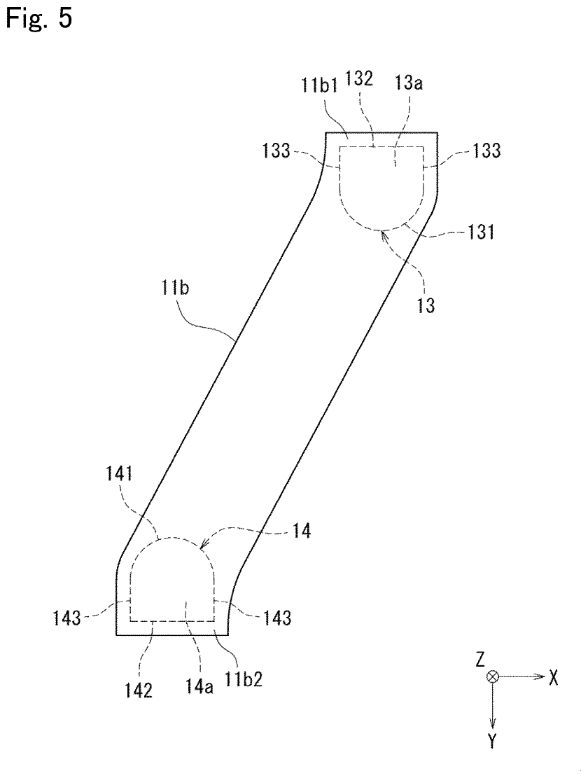

FIG. 5 is an enlarged view of a part of FIG. 1. As shown in FIG. 5, when viewed in the direction orthogonal to the bottom surface 100b, a first end portion 11b1 of the bottom surface wiring 11b and a first end portion 13a of the first penetration wiring 13 are connected, and an outer shape of the coil 110 of the first end portion 11b1 of the bottom surface wiring 11b preferably conforms to an outer shape of the coil 110 of the first end portion 13a of the first penetration wiring 13. The outer side of the coil 110 indicates the outer circumferential surface side of the coil 110. To be more specific, an external shape of the first end portion 11b1 of the bottom surface wiring 11b conforms to the outer circumferential edge 132 and the side edge 133 of the first end portion 13a of the first penetration wiring 13. According to the configuration described above, the shape of the first end portion 11b1 of the bottom surface wiring 11b can be made to correspond to the shape of the first end portion 13a of the first penetration wiring 13, and it is possible to decrease the DC electrical resistance of a connection part between the bottom surface wiring 11b and the first penetration wiring 13.

In this case, preferably, the first end portion 11b1 of the bottom surface wiring 11b is larger than the first end portion 13a of the first penetration wiring 13. Consequently, even if misalignment of the bottom surface wiring 11b occurs, it is possible to ensure the connection between the bottom surface wiring 11b and the first penetration wiring 13.

Similarly, when viewed in the direction orthogonal to the bottom surface 100b, preferably, a second end portion 11b2 of the bottom surface wiring 11b and a first end portion 14a of the second penetration wiring 14 are connected, and an outer shape of the coil 110 of the second end portion 11b2 of the bottom surface wiring 11b conforms to an outer shape of the coil 110 of the first end portion 14a of the second penetration wiring 14.

To be more specific, an external shape of the second end portion 11b2 of the bottom surface wiring 11b conforms to the outer circumferential edge 142 and the side edge 143 of the first end portion 14a of the second penetration wiring 14. According to the configuration described above, the shape of the second end portion 11b2 of the bottom surface wiring 11b can be made to correspond to the shape of the first end portion 14a of the second penetration wiring 14, and it is possible to decrease the DC electrical resistance of a connection part between the bottom surface wiring 11b and the second penetration wiring 14.

Preferably, as shown in FIG. 2, when viewed in the direction orthogonal to the bottom surface 100b, the first end portion of the bottom surface wiring 11b and the first end portion of the top surface wiring 11t overlap each other, and an angle θ formed by the bottom surface wiring 11b and the top surface wiring 11t is an acute angle. The angle θ is an angle between a center line (a chain line in FIG. 2) of a width of the bottom surface wiring 11b and a center line (a chain line in FIG. 2) of a width of the top surface wiring 11t when viewed in the direction orthogonal to the bottom surface 100b.

Preferably, as shown in FIG. 2, when viewed in the direction orthogonal to the bottom surface 100b, the angle θ formed by the bottom surface wiring 11b and the top surface wiring 11t connected to the same first penetration wiring 13 is 5° or larger and 45° or smaller (i.e., from 5° to) 45°. The angle θ is an angle between a center line (a chain line in FIG. 2) of a width of the bottom surface wiring 11b and a center line (a chain line in FIG. 2) of a width of the top surface wiring 11t when viewed in the direction orthogonal to the bottom surface 100b.

According to the configuration described above, since the coils 110 are densely wound, it is possible to improve the inductance. Since the angle θ is 45° or smaller, a coil length is shortened, the leakage flux is reduced, and the Q value is increased. The coil length indicates an interval between both end parts positioned on the outermost sides in the axis AX direction, among the bottom surface wirings 11b, the top surface wirings 11t, the first penetration wirings 13, and the second penetration wirings 14. Since the angle θ is 5° or larger, it is possible to decrease possibilities that the two first penetration wirings 13 adjacent to each other in the axis AX direction are brought into contact with each other, and it is possible to decrease possibilities that the two second penetration wirings 14 adjacent to each other in the axis AX direction are brought into contact with each other. Of all the bottom surface wirings 11b and the top surface wirings 11t, the angle θ between at least one set of the bottom surface wiring 11b and the top surface wiring 11t may be 5° or larger and 45° or smaller (i.e., from 5° to) 45°.

Preferably, similarly when viewed in the direction orthogonal to the bottom surface 100b, the angle θ formed by the bottom surface wiring 11b and the top surface wiring 11t connected to the same second penetration wiring 14 is 5° or larger and 45° or smaller (i.e., from 5° to) 45°. Consequently, since the coils 110 are densely wound, it is possible to improve the inductance.

Preferably, at least one wiring of the bottom surface wirings 11b, the top surface wirings 11t, the first penetration wirings 13, and the second penetration wirings 14 includes a void portion or a resin portion. This enables stress due to a difference in linear expansion coefficient between the wiring and the element body 10 to be absorbed by the void portion or the resin portion, thus enabling the stress to be alleviated. As a method of forming the void portion, for example, the void portion can be formed by sintering a wiring, by using a member which is burned into the material of the wiring by being sintered. As a method for forming the resin portion, for example, the resin portion can be formed by using a conductive paste in the material of the wiring.

Preferably, at least one wiring of the bottom surface wirings 11b and the top surface wirings 11t contains SiO₂. This enables a linear expansion coefficient of the wiring to be equal to the linear expansion coefficient of the element body 10 in a case where the element body 10 contains SiO₂, thus enabling cracks between the wiring and the element body 10 to be reduced.

### (First External Electrode 121 and Second External Electrode 122)

The first external electrode 121 is connected to the first end portion of the coil 110, and the second external electrode 122 is connected to the second end portion of the coil 110. The first external electrode 121 is provided on the first end surface 100e1 side with respect to a center of the element body 10 in the X direction to be exposed from the outer surface 100 of the element body 10. The second external electrode 122 is provided on the second end surface 100e2 side with respect to a center of the element body 10 in the X direction to be exposed from the outer surface 100 of the element body 10.

When viewed in the direction orthogonal to the bottom surface 100b, the first external electrode 121 and the second external electrode 122 are positioned on an inner side with respect to the outer surface 100 of the element body 10. That is, the first external electrode 121 and the second external electrode 122 are positioned on an inner side with respect to the first end surface 100e1, the second end surface 100e2, the first side surface 100s1, and the second side surface 100s2 of the element body 10.

According to the configuration described above, since the first external electrode 121 and the second external electrode 122 are not in contact with the outer surfaces 100 of the element body 10, loads applied to the first external electrode 121 and the second external electrode 122 can be decreased, and deformation and peeling of the first external electrode 121 and the second external electrode 122 can be reduced, when division into individual inductor components is performed. Therefore, even if the inductor component has a small size, it is possible to prevent the first external electrode 121 and the second external electrode 122 from being deformed or peeled off.

Note that the first external electrode 121 may be provided to be continuously connected to the bottom surface 100b and the first end surface 100e1. This enables a solder fillet to be formed on the first external electrode 121 when the inductor component 1 is mounted on a mounting substrate, since the first external electrode 121 is a so-called L-shaped electrode. Similarly, the second external electrode 122 may be provided to be continuously connected to the bottom surface 100b and the second end surface 100e2.

The first external electrode 121 has a bottom surface part 121b provided on the bottom surface 100b and a via part 121v embedded in the bottom surface 100b. The via part 121v is connected to the bottom surface part 121b. The via part 121v is connected to an end portion of the bottom surface wiring 11b positioned on the first end surface 100e1 side in the axis AX direction.

The second external electrode 122 has a bottom surface part 122b provided on the bottom surface 100b and a via part 122v embedded in the bottom surface 100b. The via part 122v is connected to the bottom surface part 122b. The via part 122v is connected to an end portion of the bottom surface wiring 11b positioned on the second end surface 100e2 side in the axis AX direction.

The first external electrode 121 has a base layer 121e1 and a plating layer 121e2 covering the base layer 121e1. The base layer 121e1 contains, for example, a conductive material such as Ag or Cu. The plating layer 121e2 contains, for example, a conductive material such as Ni or Sn. A part of the bottom surface part 121b and the via part 121v are formed by the base layer 121e1. The other part of the bottom surface part 121b is formed by the plating layer 121e2. Similarly, the second external electrode 122 has a base layer and a plating layer covering the base layer. Note that the first external electrode 121 and the second external electrode 122 may be made of a single-layer conductor material.

### (Method for Manufacturing Inductor Component 1)

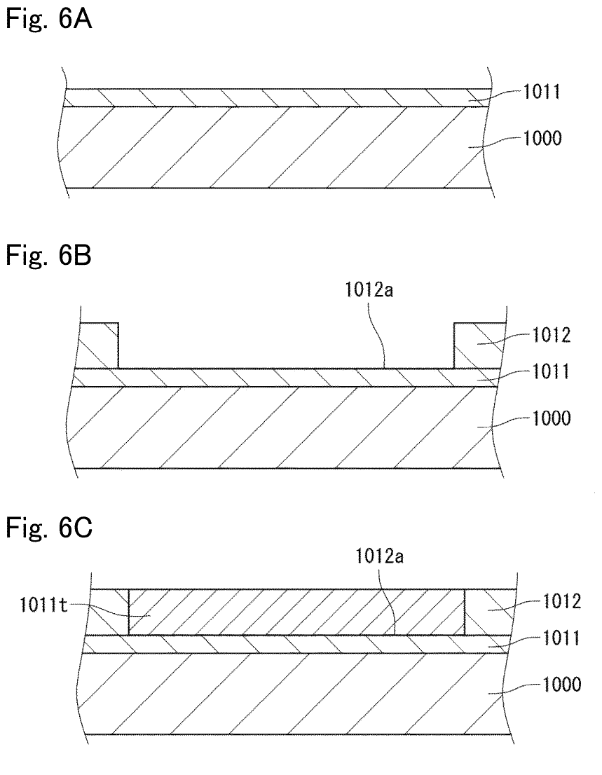

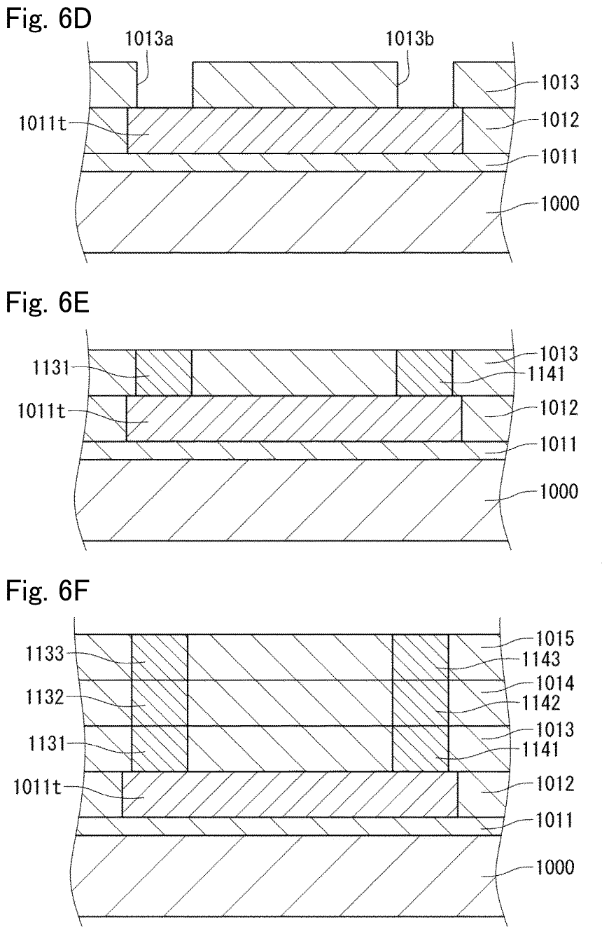

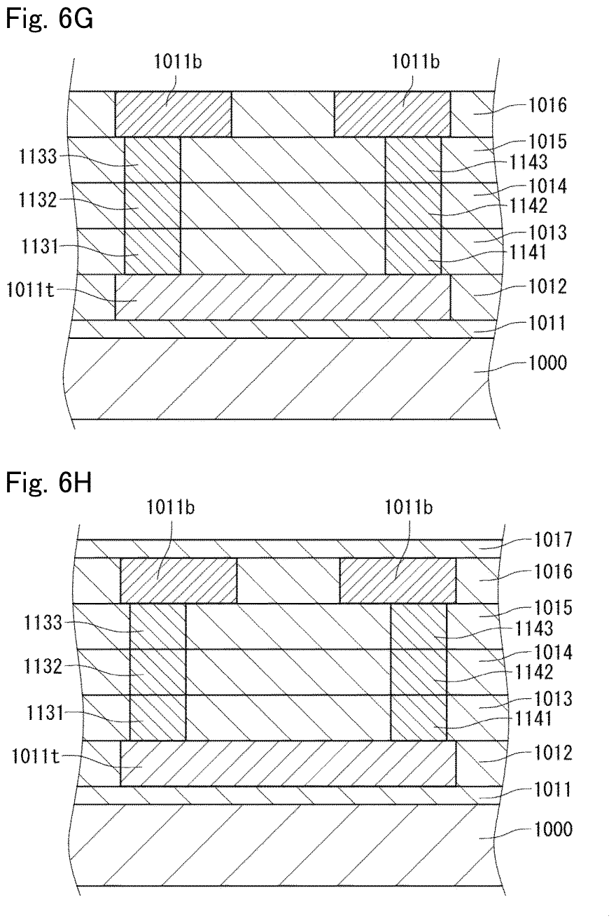

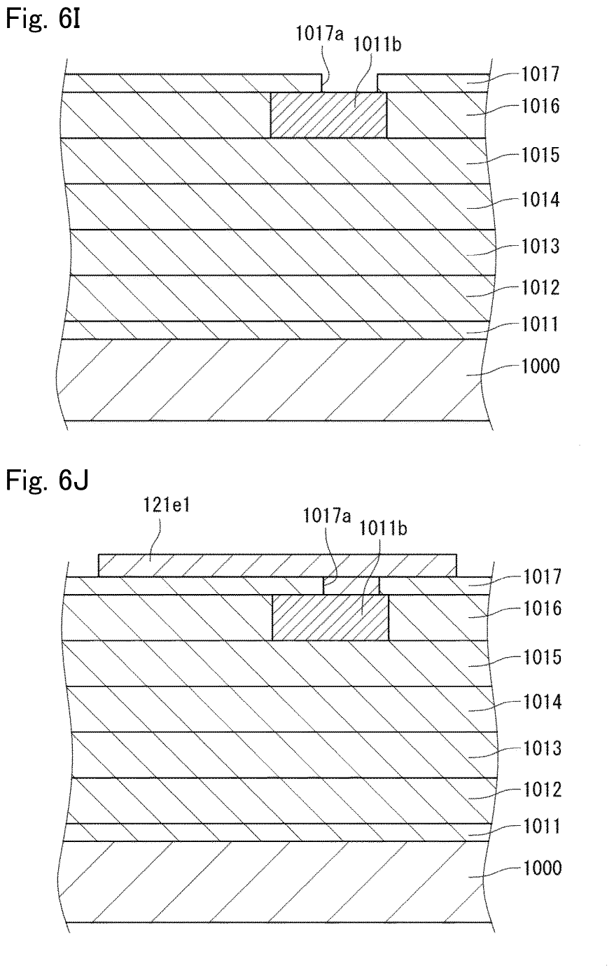

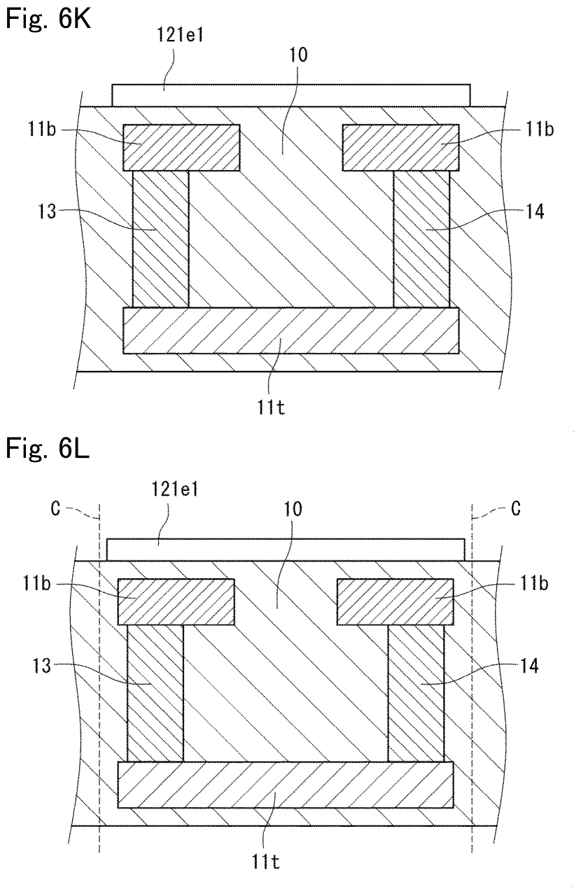

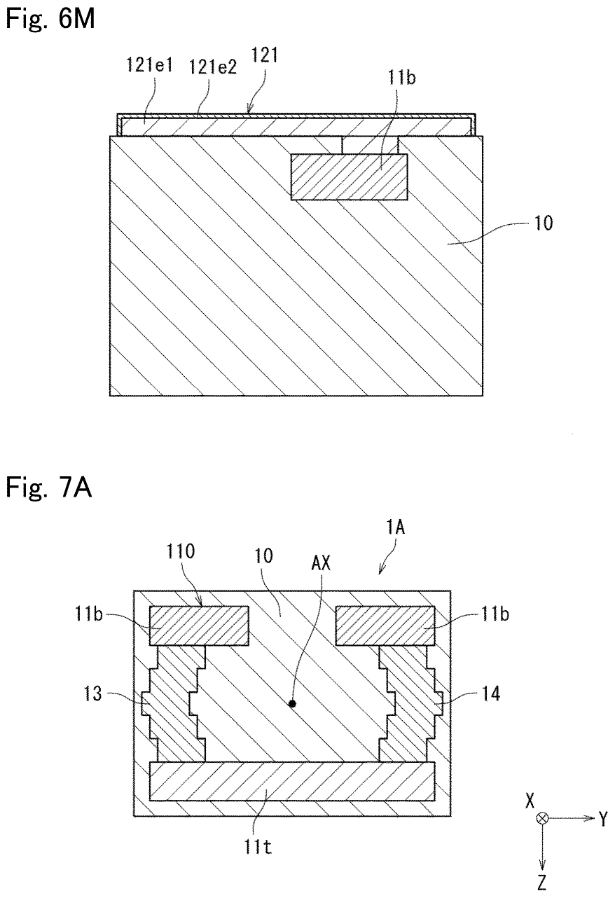

Next, a method for manufacturing the inductor component 1 will be described with reference to FIGS. 6A to 6M. FIGS. 6A to 6H, 6K, and 6L are views corresponding to a cross section taken along line II-II in FIG. 1. FIGS. 6I, 6J, and 6M are views corresponding to a cross section taken along line III-III in FIG. 1.

As shown in FIG. 6A, a first insulating layer 1011 is printed on a base substrate 1000. Examples of materials of the base substrate 1000 include a glass substrate, a silicon substrate, an alumina substrate, or the like, and examples of materials of the first insulating layer 1011 include a resin such as epoxy or polyimide, or an inorganic insulating film such as SiO or SiN.

As shown in FIG. 6B, a second insulating layer 1012 is printed on the first insulating layer 1011. A groove 1012a is provided in the second insulating layer 1012. In this case, for example, the groove 1012a is formed by the photolithography process. Note that the groove may be formed as a printed pattern from the beginning.

As shown in FIG. 6C, a top surface conductor layer 1011t is printed in the groove 1012a. Examples of materials of the top surface conductor layer 1011t include Ag, Cu, Au, Al, an alloy containing at least one of these elements, or a solder paste. In this case, for example, the top surface conductor layer 1011t is formed as a printed pattern to remain only in the groove 1012a. Note that, after the top surface conductor layer 1011t is printed on the second insulating layer 1012, the top surface conductor layer 1011t may remain only in the groove 1012a by the photolithography process.

As shown in FIG. 6D, a third insulating layer 1013 is printed on the second insulating layer 1012. The third insulating layer 1013 has a first groove 1013a and a second groove 1013b. The first groove 1013a and the second groove 1013b are formed in the same method as described in FIG. 6B.

As shown in FIG. 6E, a first penetration conductor layer 1131 as a first layer is printed in the first groove 1013a, and a second penetration conductor layer 1141 as the other first layer is printed in the second groove 1013b. The first penetration conductor layer 1131 as the first layer and the second penetration conductor layer 1141 as the other first layer are formed by the same method described in FIG. 6C.

By repeating the above-described processes, as shown in FIG. 6F, a fourth insulating layer 1014 is provided on the third insulating layer 1013, and a first penetration conductor layer 1132 as a second layer and a second penetration conductor layer 1142 as the other second layer are provided in two respective grooves provided in the fourth insulating layer 1014. Further, a fifth insulating layer 1015 is provided on the fourth insulating layer 1014, and a first penetration conductor layer 1133 as a third layer and a second penetration conductor layer 1143 as the other third layer are provided in two respective grooves provided in the fifth insulating layer 1015.

As shown in FIG. 6G, a sixth insulating layer 1016 is provided on the fifth insulating layer 1015, and a bottom surface conductor layer 1011b is provided in a groove provided in the sixth insulating layer 1016. A material of the bottom surface conductor layer 1011b is the same as the material of the top surface conductor layer 1011t. As shown in FIG. 6H, a seventh insulating layer 1017 is provided on the sixth insulating layer 1016.

As shown in FIG. 6I, a groove 1017a is provided in the seventh insulating layer 1017 such that a part of the bottom surface conductor layer 1011b is exposed. As shown in FIG. 6J, a base conductor layer 1121e1 is provided on the seventh insulating layer 1017 and in the groove 1017a. Examples of materials of the base conductor layer 1121e1 include resin pastes of Ag or Cu.

As shown in FIG. 6K, an entire layered body is sintered in a furnace at a high temperature (for example, 500° C. or higher). The first to seventh insulating layers 1011 to 1017 are sintered to form the element body 10, the top surface conductor layer 1011t is sintered to form the top surface wiring 11t, the bottom surface conductor layer 1011b is sintered to form the bottom surface wiring 11b, the first penetration conductor layers 1131 to 1133 as the first to third layers are sintered to form the first penetration wiring 13, the second penetration conductor layers 1141 to 1143 as the first to third other layers are sintered to form the second penetration wiring 14, and the base conductor layer 1121e1 is sintered to form the base layer 121e1. Hence, it is possible to improve the strength by sintering the insulating layers, and a resin component which does not need to be contained in the conductor layers can be volatilized by sintering the conductor layers, and a conductor material contained in the conductor layers can be fused to realize high conductivity. The base substrate 1000 may be peeled off by decomposing a surface during sintering, may be mechanically removed by performing grinding or the like before and after the sintering, or may be chemically removed by performing etching or the like before and after the sintering.

As shown in FIG. 6L, division into individual inductor components is performed along a cutting line C. As shown in FIG. 6M, the plating layer 121e2 is formed by performing barrel plating to cover the base layer 121e1, and the first external electrode 121 is formed. Consequently, as shown in FIG. 2, the inductor component 1 is manufactured.

### 3. MODIFICATION EXAMPLES

### First Modification Example

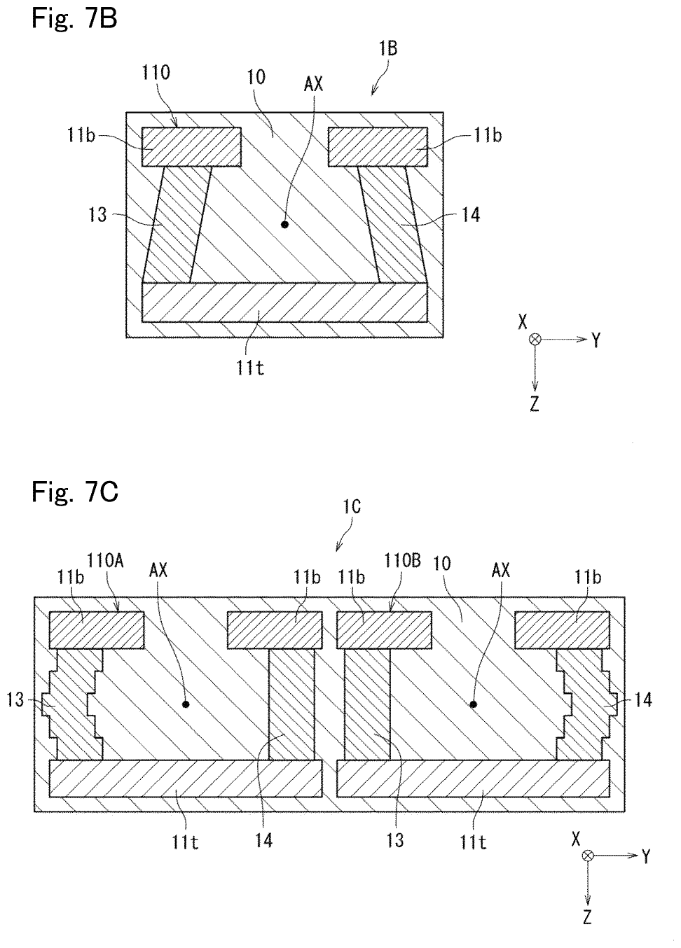

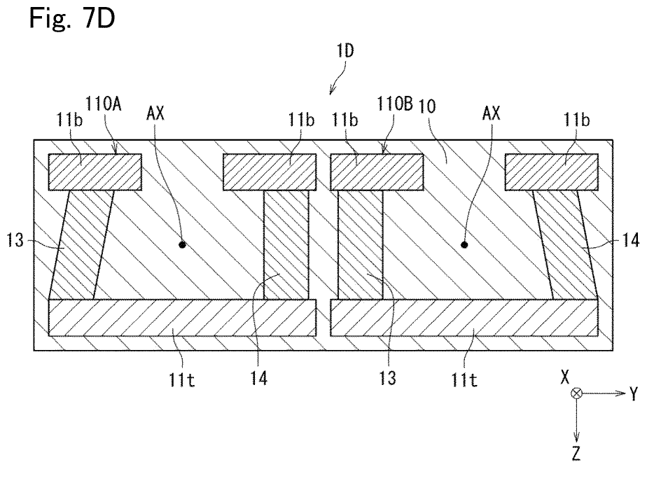

FIG. 7A is a view showing a first modification example of the inductor component, and the view corresponds to the cross section taken along line II-II in FIG. 1. As shown in FIG. 7A, in an inductor component 1A of the first modification example, the first penetration wiring 13 and the second penetration wiring 14 are not parallel to each other when viewed in the direction parallel to the axis AX of the coil 110. This enables a distance between the first penetration wiring 13 and the second penetration wiring 14 to be increased and enables the inner diameter of the coil 110 to be increased such that it is possible to improve the Q value.

To be more specific, the first penetration wiring 13 and the second penetration wiring 14 are bent at respective centers thereof in the Z direction such that a space therebetween is widened toward the centers. That is, each of the first penetration wiring 13 and the second penetration wiring 14 has a shape expanding outward in a radial direction of the coil 110 toward the center in the Z direction. In addition, each of the first penetration wiring 13 and the second penetration wiring 14 has a stepped shape in the Z direction. According to the configuration described above, in a case where the first penetration wiring 13 and the second penetration wiring 14 are each formed by layering a plurality of conductor layers, the first penetration wiring 13 and the second penetration wiring 14 can be easily formed in the stepped shape by shifting and layering each conductor layer.

### Second Modification Example

FIG. 7B is a view showing a second modification example of the inductor component, and the view corresponds to the cross section taken along line II-II in FIG. 1. As shown in FIG. 7B, in an inductor component 1B of the second modification example, the first penetration wiring 13 and the second penetration wiring 14 are not parallel to each other when viewed in the direction parallel to the axis AX of the coil 110. This enables a distance between the first penetration wiring 13 and the second penetration wiring 14 to be increased and enables the inner diameter of the coil 110 to be increased such that it is possible to improve the Q value.

To be more specific, the first penetration wirings 13 and the second penetration wirings 14 are inclined such that a space therebetween is widened toward the top surface wiring 11t side in the Z direction. That is, each of the first penetration wirings 13 and the second penetration wirings 14 has a shape expanding outward in the radial direction of the coil 110 toward the top surface wiring 11t in the Z direction. As described above, the coil 110 has a trapezoidal shape when viewed from the axis AX direction. According to the configuration described above, the first penetration wirings 13 and the second penetration wirings 14 can be linearly formed and shortened, and the DC resistance of the first penetration wirings 13 and the second penetration wirings 14 can be reduced.

### Third Modification Example

FIG. 7C is a view showing a third modification example of the inductor component, and the view corresponds to the cross section taken along line II-II in FIG. 1. As shown in FIG. 7C, an inductor component 1C of the third modification example includes a first coil 110A and a second coil 110B as compared with the inductor component 1A of the first modification example shown in FIG. 7A.

In the first coil 110A, the first penetration wiring 13 and the second penetration wiring 14 are not parallel to each other when viewed in the direction parallel to the axis AX. This enables a distance between the first penetration wiring 13 and the second penetration wiring 14 to be increased and enables the inner diameter of the coil 110A to be increased such that it is possible to improve the Q value.

To be more specific, the first penetration wiring 13 has the same configuration as that of the first penetration wiring 13 of the inductor component 1A of the first modification example. Meanwhile, the second penetration wiring 14 has a linear shape parallel to the Z direction. That is, the first penetration wiring 13 is bent at a center thereof in the Z direction such that a space between the first penetration wiring 13 and the second penetration wiring 14 is widened toward the center. The first penetration wiring 13 has a stepped shape in the Z direction. According to the configuration described above, in a case where the first penetration wiring 13 is formed by layering a plurality of conductor layers, the first penetration wiring 13 can be easily formed in the stepped shape by shifting and layering each conductor layer.

In the second coil 110B, the first penetration wiring 13 and the second penetration wiring 14 are not parallel to each other when viewed in the direction parallel to the axis AX. This enables a distance between the first penetration wiring 13 and the second penetration wiring 14 to be increased and enables the inner diameter of the coil 110B to be increased such that it is possible to improve the Q value.

To be more specific, the second penetration wiring 14 has the same configuration as that of the second penetration wiring 14 of the inductor component 1A of the first modification example. Meanwhile, the first penetration wiring 13 has a linear shape parallel to the Z direction. That is, the second penetration wiring 14 is bent at a center thereof in the Z direction such that a space between the first penetration wiring 13 and the second penetration wiring 14 is widened toward the center. The second penetration wiring 14 has a stepped shape in the Z direction. According to the configuration described above, in a case where the second penetration wiring 14 is formed by layering a plurality of conductor layers, the second penetration wiring 14 can be easily formed in the stepped shape by shifting and layering each conductor layer.

### Fourth Modification Example

FIG. 7D is a view showing a fourth modification example of the inductor component, and the view corresponds to the cross section taken along line II-II in FIG. 1. As shown in FIG. 7D, an inductor component 1D of the fourth modification example includes a first coil 110A and a second coil 110B as compared with the inductor component 1B of the second modification example shown in FIG. 7B.

In the first coil 110A, the first penetration wiring 13 and the second penetration wiring 14 are not parallel to each other when viewed in the direction parallel to the axis AX. This enables a distance between the first penetration wiring 13 and the second penetration wiring 14 to be increased and enables the inner diameter of the coil 110A to be increased such that it is possible to improve the Q value.

To be more specific, the first penetration wiring 13 has the same configuration as that of the first penetration wiring 13 of the inductor component 1B of the second modification example. Meanwhile, the second penetration wiring 14 has a linear shape parallel to the Z direction. That is, the first penetration wiring 13 is inclined such that a space between the first penetration wiring 13 and the second penetration wiring 14 is widened toward the top surface wiring 11t side in the Z direction. According to the configuration described above, the first penetration wirings 13 and the second penetration wirings 14 can be linearly formed and shortened, and the DC resistance of the first penetration wirings 13 and the second penetration wirings 14 can be reduced.

In the second coil 110B, the first penetration wiring 13 and the second penetration wiring 14 are not parallel to each other when viewed in the direction parallel to the axis AX. This enables a distance between the first penetration wiring 13 and the second penetration wiring 14 to be increased and enables the inner diameter of the coil 110B to be increased such that it is possible to improve the Q value.

To be more specific, the second penetration wiring 14 has the same configuration as that of the second penetration wiring 14 of the inductor component 1B of the second modification example. Meanwhile, the first penetration wiring 13 has a linear shape parallel to the Z direction. That is, the second penetration wiring 14 is inclined such that a space between the first penetration wiring 13 and the second penetration wiring 14 is widened toward the top surface wiring 11t side in the Z direction. According to the configuration described above, the first penetration wirings 13 and the second penetration wirings 14 can be linearly formed, and the electrical resistance of the first penetration wirings 13 and the second penetration wirings 14 can be reduced.

### Second Embodiment

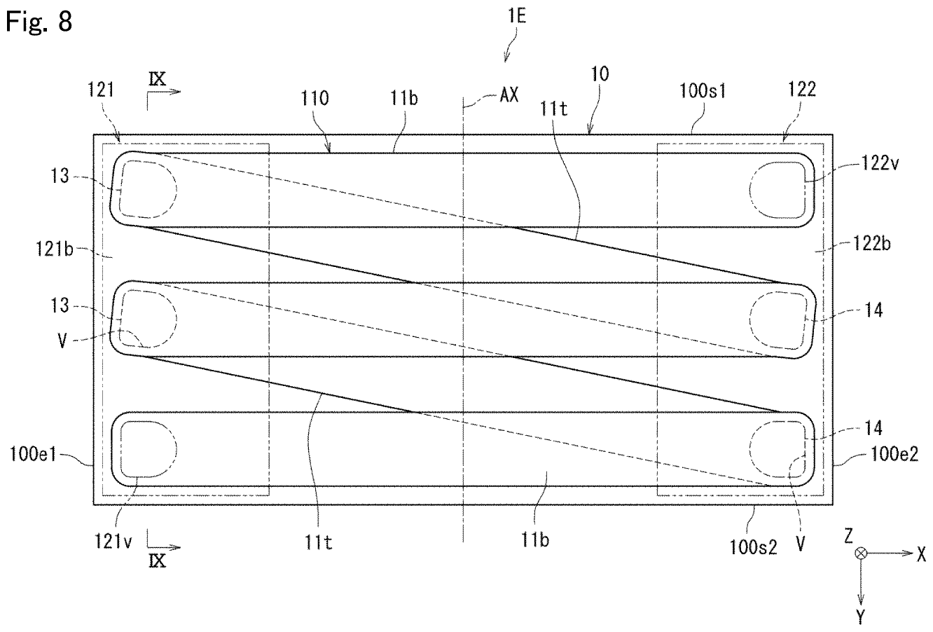

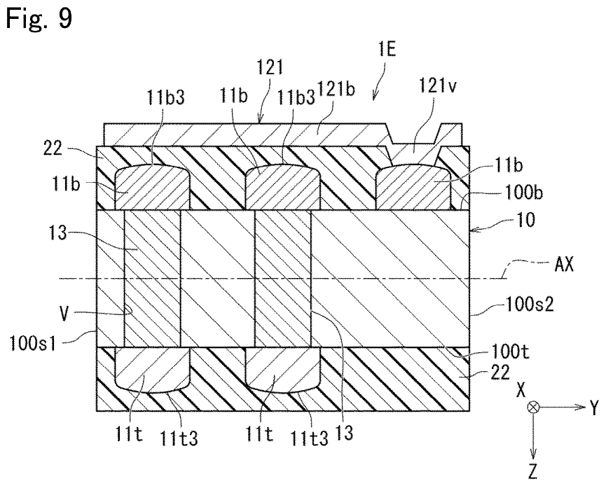

FIG. 8 shows a schematic bottom view of a second embodiment of the inductor component from a bottom surface side. FIG. 9 is a cross-sectional view taken along line IX-IX in FIG. 8. In FIG. 8, for convenience, an insulating layer is omitted, and the external electrodes are drawn by two-dot chain lines. In addition, in FIG. 8, the element body 10 is drawn transparently so that a structure thereof can be easily understood. The second embodiment differs from the first embodiment mainly in the position of the axis of the coil, the orientation of the penetration wiring, the material of the element body, and providing of an insulating layer, and these different configurations will be mainly described below. The other configurations are the same as those of the first embodiment, and the description thereof will be omitted.

### 1. CONFIGURATIONS OF RESPECTIVE UNITS

### (Inductor Component 1E)

As shown in FIG. 8, in an inductor component 1E, an axis AX of a coil 110 is perpendicular to the X direction. To be more specific, the axis AX is parallel to the Y direction and passes a center of the element body 10 in the X direction. This enables interference in magnetic flux of the coil 110 by the first external electrode 121 and the second external electrode 122 to be reduced, and it is possible to improve the efficiency of acquisition of inductance.

A length of the coil 110 in the axis AX direction is shorter than an inner diameter of the coil 110. The length of the coil 110 in the axis AX direction is also referred to as a coil length. This enables the Q value to be improved since the coil length is short and the coil inner diameter is large. The inner diameter of the coil indicates an equivalent circle diameter based on a minimum area of a region surrounded by the coil 110 when viewed therethrough in the axis AX direction.

### (Element Body 10)

The element body 10 is an inorganic insulating body. The material of the element body 10 is preferably glass, and this enables an eddy current to be reduced and enables the Q value to be increased since the glass has high insulation properties. The element body 10 preferably contains an Si element, and this enables the thermal stability of the element body 10 to be increased, thus, enabling variations in dimension or the like of the element body 10 due to heat to be reduced and enabling variations in electrical characteristics to be decreased.

The element body 10 is preferably a single-layer glass plate. This enables the strength of the element body 10 to be ensured. In addition, in the case of the single-layer glass plate, since dielectric loss is small, the Q value at a high frequency can be increased. In addition, since no sintering process for such a sintered body is performed, deformation of the element body 10 during sintering can be reduced. Hence, it is possible to reduce pattern misalignment and provide an inductor component with a small inductance tolerance.

As a material of the single-layer glass plate, a glass plate having photosensitivity represented by Foturan II (Schott AG's registered trademark) is preferable from the viewpoint of a manufacturing method. In particular, the single-layer glass plate preferably contains cerium oxide (ceria: CeO₂), and in this case, cerium oxide serves as a sensitizer, and processing by photolithography becomes easier.

However, since the single-layer glass plate can be processed by machining such as drilling or sandblasting, dry/wet etching using a photoresist/metal mask, laser processing, or the like, the single-layer glass plate may be a non-photosensitive glass plate. In addition, the single-layer glass plate may be obtained by sintering a glass paste, or may be formed by a known method such as a float process.

### (Insulating Body 22)

As shown in FIG. 9, the inductor component 1E includes an insulating body 22. The insulating body 22 covers both the bottom surface 100b and the top surface 100t of the element body 10. Note that the insulating body 22 may be provided only on the bottom surface 100b of the bottom and top surfaces 100b and 1100t.

The insulating body 22 is a member that protects the wirings from an external force by covering the wirings (the bottom surface wirings 11b and the top surface wirings 11t), and has a role of preventing the wirings from being damaged and a role of improving insulation properties of the wirings. The insulating body 22 is preferably an organic insulating body. For example, the insulating body 22 may be a film made of a resin such as epoxy or polyimide which is easily formed. In particular, the insulating body 22 is preferably made of a material having a low dielectric constant. Consequently, in a case where the insulating body 22 is present between the coil 110 and the external electrode 121 or 122, it is possible to decrease the stray capacitance formed between the coil 110 and the external electrode 121 or 122. The insulating body 22 can be formed, for example, by laminating a resin film such as ABF GX-92 (manufactured by Ajinomoto Fine-Techno Co., Inc.), applying and thermal-curing a paste-like resin, or the like. Note that the insulating body 22 may be, for example, an inorganic film made of an oxide such as silicon or hafnium, a nitride, an oxynitride, or the like, which is excellent in insulating properties and thinning.

Preferably, when the element body 10 is the inorganic insulating body, and the insulating body 22 is an organic insulating body, the organic insulating body is positioned on an inner side with respect to the outer surfaces 100 of the inorganic insulating body when viewed in the direction orthogonal to the bottom surface 100b. According to this, since the organic insulating body is provided, the organic insulating body easily imparts flowability, the organic insulating body easily fills a space between wirings adjacent to each other and enables insulating properties to be improved, in a case where the wirings (the bottom surface wirings 11b and the top surface wirings 11t) are covered with the organic insulating body. In addition, since the organic insulating body is not in contact with the outer surface of the inorganic insulating body, it is possible to decrease a load applied to the organic insulating body and reduce deformation and peeling of the organic insulating body when division into individual inductor components is performed.

### (Coil 110)

As shown in FIG. 8, the bottom surface wiring 11b extends only in one direction. To be more specific, the bottom surface wirings 11b have a shape extending in the X direction. The plurality of bottom surface wirings 11b are arranged parallel to each other in the Y direction. The top surface wirings 11t extend only in one direction. To be more specific, the top surface wirings 11t slightly tilt in the Y direction and extend in the X direction. The plurality of top surface wirings 11t are arranged parallel to each other in the Y direction.

The first penetration wirings 13 are disposed in the through-holes V of the element body 10 on the first end surface 100e1 side with respect to the axis AX, and the second penetration wirings 14 are disposed in the other through-holes V of the element body 10 on the second end surface 100e2 side with respect to the axis AX. Each of the first penetration wirings 13 and the second penetration wirings 14 extends in a direction orthogonal to the bottom surface 100b and the top surface 100t. The plurality of first penetration wirings 13 and the plurality of second penetration wirings 14 are all arranged parallel to each other in the Y direction.

As shown in FIG. 9, on a cross section orthogonal to an extending direction of the bottom surface wirings 11b, upper surfaces 11b3 of the bottom surface wirings 11b which are positioned on a side opposite to the axis AX preferably have a convex shape projecting upward on the side opposite to the axis AX. Consequently, it is possible to increase a distance between the upper surfaces 11b3 of two bottom surface wirings 11b adjacent to each other in the axis AX direction, and it is possible to decrease parasitic capacitance between the bottom surface wirings 11b adjacent to each other in the axis AX direction such that it is possible to increase the self-resonant frequency of the inductor component 1E.

Similarly, on a cross section orthogonal to an extending direction of the top surface wirings 11t, upper surfaces 11t3 of the top surface wirings 11t which are positioned on a side opposite to the axis AX preferably have a convex shape projecting upward on the side opposite to the axis AX. Consequently, it is possible to increase a distance between the upper surfaces 11t3 of two top surface wirings 11t adjacent to each other in the axis AX direction, and it is possible to decrease parasitic capacitance between the top surface wirings 11t adjacent to each other in the axis AX direction such that it is possible to increase the self-resonant frequency of the inductor component 1E.

Preferably, the first external electrode 121 is disposed on the bottom surface wirings 11b, and the upper surfaces 11b3 of the bottom surface wirings 11b are opposite to the first external electrode 121. Consequently, it is possible to increase a distance between the upper surfaces 11b3 of the first external electrode 121 and the bottom surface wirings 11b, and it is possible to decrease parasitic capacitance between the first external electrode 121 and the bottom surface wirings 11b such that it is possible to increase the self-resonant frequency of the inductor component 1E.

Similarly, preferably, the second external electrode 122 is disposed on the bottom surface wirings 11b, and the upper surfaces 11b3 of the bottom surface wirings 11b are opposite to the second external electrode 122. Consequently, it is possible to increase a distance between the upper surfaces 11b3 of the second external electrode 122 and the bottom surface wirings 11b, and it is possible to decrease parasitic capacitance between the second external electrode 122 and the bottom surface wirings 11b such that it is possible to increase the self-resonant frequency of the inductor component 1E.

Note that the first external electrode 121 and the second external electrode 122 may not be disposed immediately on the bottom surface wirings 11b, and may be slightly separated from the bottom surface wirings 11b when viewed in the direction orthogonal to the bottom surface 100b. Even in this case, it is possible to decrease the parasitic capacitance between the first external electrode 121 and the second external electrode 122 and the bottom surface wiring 11b.

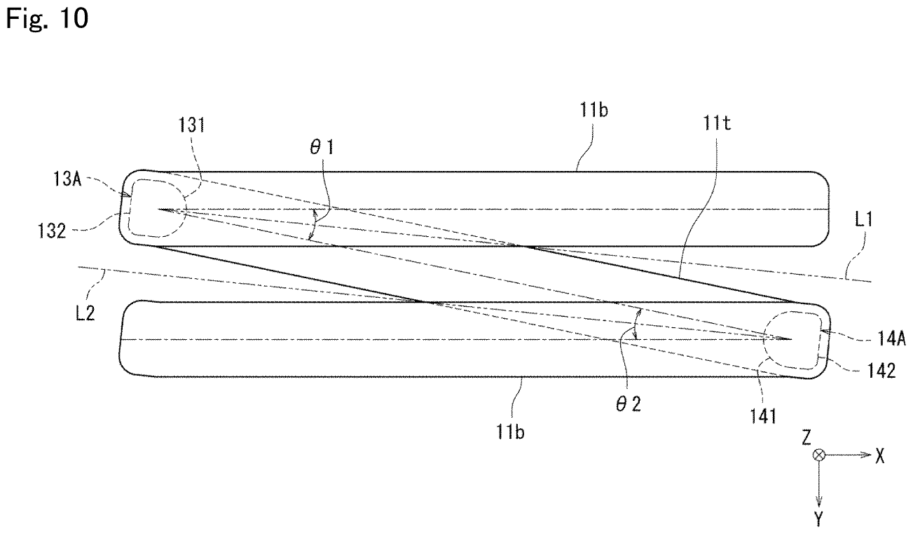

FIG. 10 is a schematic bottom view of the coil 110 from the bottom surface 100b side. As shown in FIG. 10, when viewed in the direction orthogonal to the bottom surface 100b, a bisector (hereinafter, referred to as a first bisector L1) of a first angle θ1 formed by the bottom surface wiring 11b and the top surface wiring 11t connected to a reference first penetration wiring 13A which is one of the first penetration wirings 13 is defined.

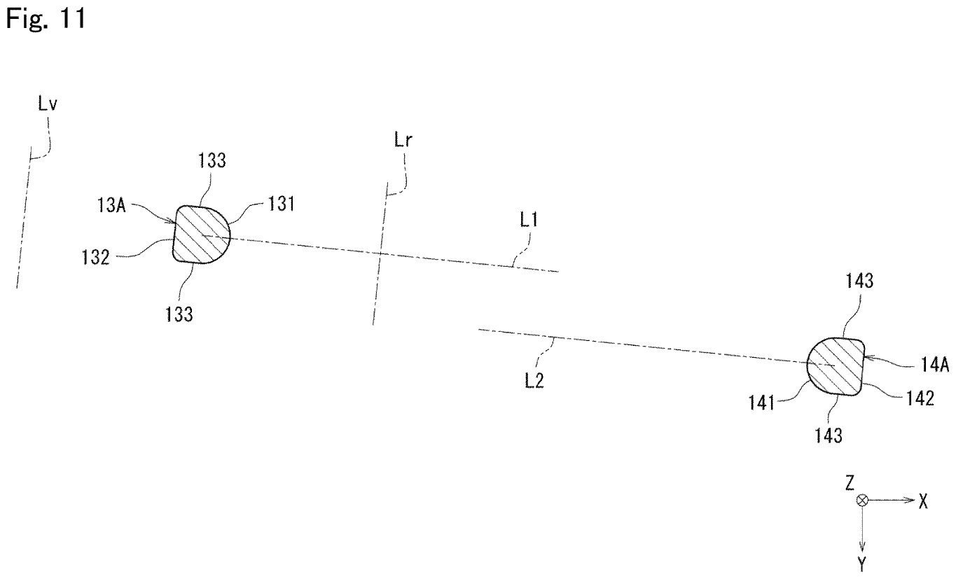

As shown in FIG. 11, on a cross section parallel to the bottom surface 100b and including the axis AX, the reference first penetration wiring 13A has an inner circumferential edge 131 facing the first bisector L1 side and an outer circumferential edge 132 facing a side opposite to the first bisector L1. The length of the inner circumferential edge 131 is longer than the length of the outer circumferential edge 132.

The inner circumferential edge 131 is a region on an entire circumferential edge of the reference first penetration wiring 13A which is projected on an orthogonal line Lr, when the reference first penetration wiring 13A is projected toward the orthogonal line Lr orthogonal to the first bisector L1 in a direction parallel to the first bisector L1. The outer circumferential edge 132 is a region on the entire circumferential edge of the reference first penetration wiring 13A which is projected on a virtual line Lv, when the virtual line Lv is defined to be parallel to the orthogonal line Lr on a side opposite to the orthogonal line Lr with respect to the reference first penetration wiring 13A, and the reference first penetration wiring 13A is projected toward the virtual line Lv in a direction parallel to the first bisector L1.

According to the configuration described above, since a length of the inner circumferential edge 131 is longer than a length of the outer circumferential edge 132, it is possible to increase a surface area of an inner surface of the reference first penetration wiring 13A. Consequently, it is possible to increase the surface area of the inner surface of the coil 110 such that the electrical resistance value at the high frequency is decreased, and the Q value at the high frequency is improved. Note that all the first penetration wirings 13 may have the same configuration as that of the reference first penetration wiring 13A.

Similarly, as shown in FIG. 10, when viewed in the direction orthogonal to the bottom surface 100b, a bisector (hereinafter, referred to as a second bisector L2) of a second angle θ2 formed by the bottom surface wiring 11b and the top surface wiring 11t connected to a reference second penetration wiring 14A which is one of the second penetration wirings 14 is defined.

As shown in FIG. 11, on a cross section parallel to the bottom surface 100b and including the axis AX, the reference second penetration wiring 14A has an inner circumferential edge 131 facing the second bisector L2 side and an outer circumferential edge 132 facing a side opposite to the second bisector L2. The length of the inner circumferential edge 131 is longer than the length of the outer circumferential edge 132. Consequently, it is possible to increase a surface area of an inner surface of the reference second penetration wiring 14A such that it is possible to further increase the surface area of the inner surface of the coil 110, the electrical resistance value at a high frequency is further decreased, and the Q value at the high frequency is further improved. Note that all the second penetration wirings 14 may have the same configuration as that of the reference second penetration wiring 14A.

Preferably, an orientation of a curved portion of the inner circumferential edge 131 of the reference first penetration wiring 13A coincides with the first bisector L1. Here, since the entire inner circumferential edge 131 is a curved portion, an orientation of the curved portion is a direction in which a midpoint of the inner circumferential edge 131 and a center line of the first penetration wiring 13 are connected. Note that all the first penetration wirings 13 may have the same configuration as that of the reference first penetration wiring 13A.

Preferably, an orientation of a curved portion of the inner circumferential edge 131 of the reference second penetration wiring 14A coincides with the second bisector L2. Here, since the entire inner circumferential edge 131 is a curved portion, an orientation of the curved portion is a direction in which a midpoint of the inner circumferential edge 131 and a center line of the second penetration wiring 14 are connected. Note that all the second penetration wirings 14 may have the same configuration as that of the reference second penetration wiring 14A.

Note that angles formed by all the bottom surface wirings 11b and the top surface wirings 11t may be different from each other, and in this case, all the bisectors are not parallel to each other. In addition, orientations of the curved portions of the inner circumferential edges 131 of all the first penetration wirings 13 may be the same as or different from each other. Orientations of the curved portions of the inner circumferential edges 141 of all the second penetration wirings 14 may be the same as or different from each other.

### (Method for Manufacturing Inductor Component 1E)

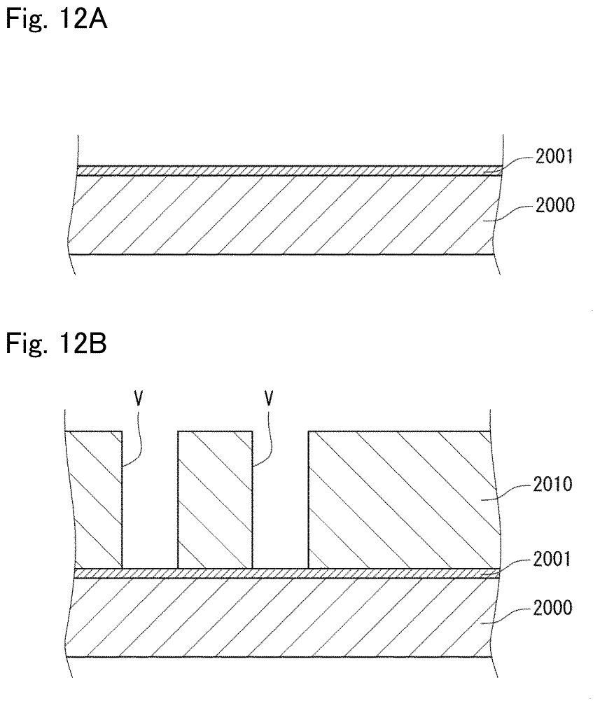

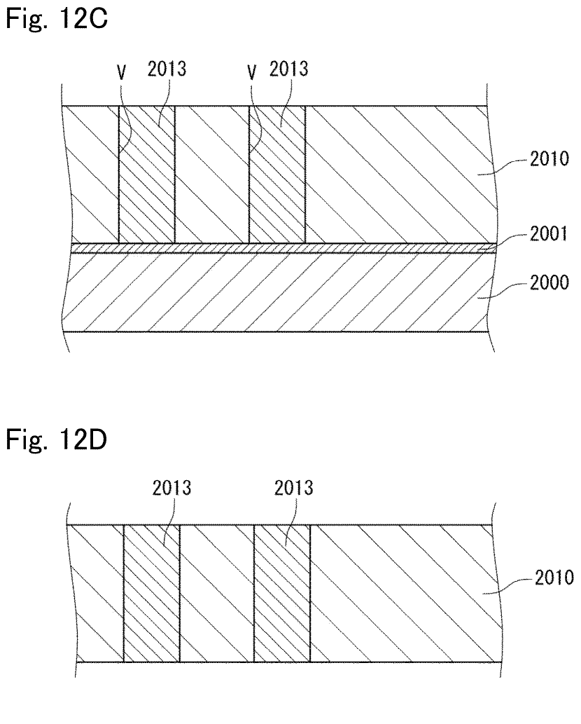

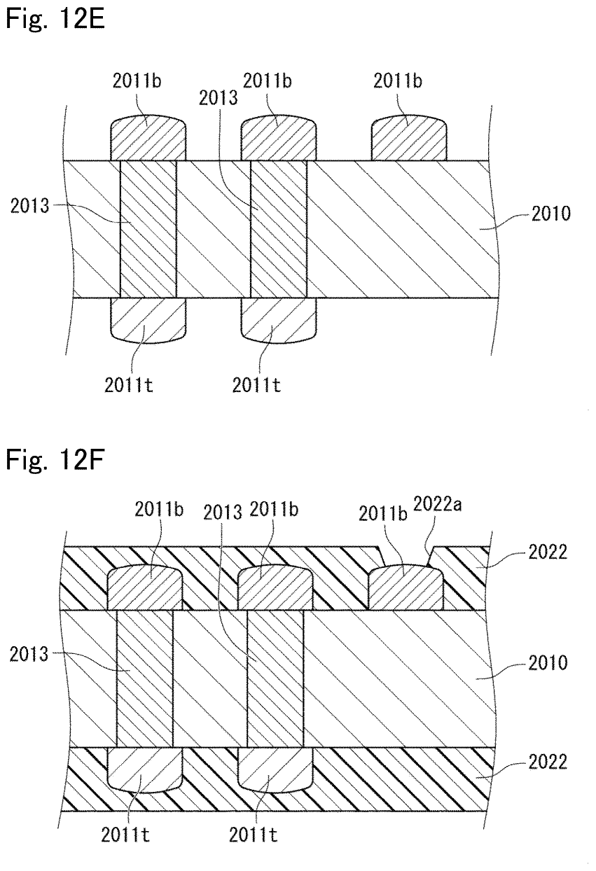

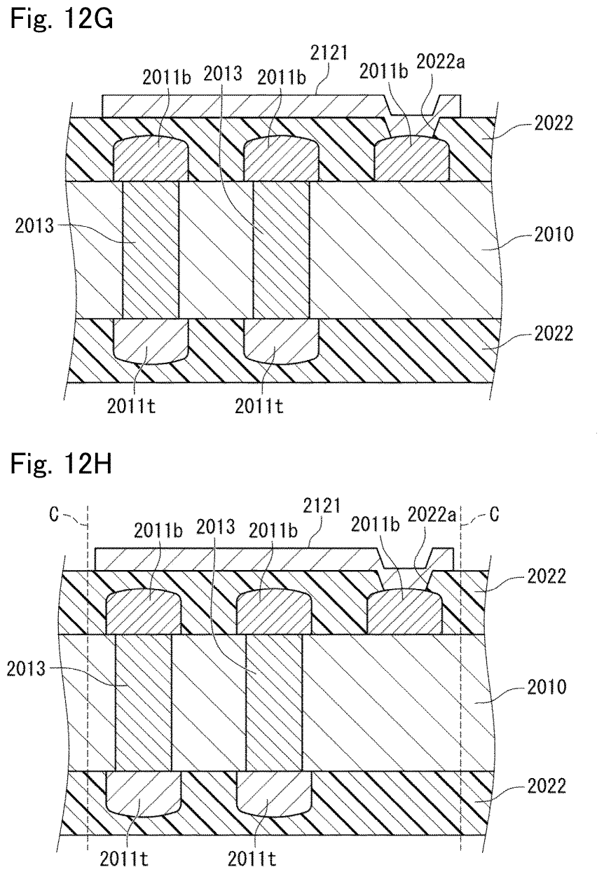

Next, a method for manufacturing the inductor component 1E will be described with reference to FIGS. 12A to 12H. FIGS. 12A to 12H are views corresponding to a cross section taken along line IX-IX in FIG. 8.

As shown in FIG. 12A, copper foil 2001 is printed on a base substrate 2000. A material of the base substrate 2000 is the same as that of the base substrate 1000 of the first embodiment.

As shown in FIG. 12B, a glass substrate 2010 which becomes the element body 10 is provided on the base substrate 2000. For example, the base substrate 2000 and the glass substrate 2010 are brought into close contact with each other using a jig such as a conductive tape, a pin, or a frame. The glass substrate 2010 has a through-hole V. The glass substrate 2010 is, for example, a through glass via (TGV) substrate. The TGV substrate is a substrate in which a through-hole is formed in advance by a laser, photolithography, or the like. The glass substrate 2010 may be, for example, a through silicon via (TSV) substrate, or may be another substrate. In addition, Ti/Cu or other necessary conductive materials may be deposited on a surface of the glass substrate 2010 in advance as seeds by sputtering or the like.

As shown in FIG. 12C, a first penetration conductor layer 2013 which becomes the first penetration wiring 13 is formed in the through-hole V of the glass substrate 2010. Although not shown, similarly, a second penetration conductor layer which becomes the second penetration wiring 14 is formed in the through-hole V. To be more specific, by supplying electric power from the copper foil 2001 on the base substrate 2000, electrolytic plating is performed on the through-hole V of the glass substrate 2010 to form the first penetration conductor layer 2013. Otherwise, a seed layer may be formed on the surface of the glass substrate 2010 or an inner surface of the through-hole V by sputtering or the like, and the penetration conductor layer may be formed by using a known method such as fill plating, conformal plating, or a printing filling method of a conductive paste. In a case where there is unnecessary plating growth on the surface of the glass substrate 2010, an unnecessary part is removed by polishing, CMP, wet etching (etchback), or dry etching.

As shown in FIG. 12D, the base substrate 2000 is peeled off from the glass substrate 2010. In this case, the base substrate 2000 may be mechanically removed by grinding or the like, or may be chemically removed by etching or the like.

As shown in FIG. 12E, a bottom surface conductor layer 2011b which becomes the bottom surface wiring 11b and a top surface conductor layer 2011t which becomes the top surface wiring 11t are formed on the glass substrate 2010. To be more specific, a seed layer (not shown) is provided on the entire surface of the glass substrate 2010, and patterned photoresist is formed on the seed layer. A copper layer is formed on the seed layer in an opening portion of the photoresist by electrolytic plating. The photoresist and the seed layer are removed by wet etching or dry etching. Consequently, the bottom surface conductor layer 2011b and the top surface conductor layer 2011t patterned in an arbitrary shape are formed. In this case, the bottom surface conductor layer 2011b and the top surface conductor layer 2011t may be formed one by one, or may be formed simultaneously. In addition, shapes of the upper surfaces of the top surface wirings and the bottom surface wirings may be formed into convex curved surfaces by optimizing agitation conditions of an additive and an electrolytic plating solution.

As shown in FIG. 12F, an insulating layer 2022 serving as the insulating body 22 is provided on a top surface and a bottom surface of the glass substrate 2010 to cover the conductor layer. In this case, the insulating layer 2022 on the bottom surface side and the insulating layer 2022 on the top surface side may be formed one by one, or may be formed simultaneously. Thereafter, a hole 2022a is formed in the bottom surface conductor layer 2011b of the insulating layer 2022 on the bottom surface side by photolithography or laser processing.

As shown in FIG. 12G, a first external electrode conductor layer 2121 which becomes the first external electrode 121 is provided on the insulating layer 2022 on the bottom surface side. In this case, the first external electrode conductor layer 2121 is connected to the bottom surface conductor layer 2011b via the hole 2022a. To be more specific, a Pd catalyst (not shown) is provided on the insulating layer 2022 on the bottom surface side, and an Ni/Au plated layer is formed by electroless plating. Patterned photoresist is formed on the plating layer. A plating layer in an opening portion of the photoresist is removed by wet etching or dry etching. Consequently, the first external electrode conductor layer 2121 patterned in an arbitrary shape is formed. Alternatively, a seed layer (not shown) is provided on the insulating layer 2022 on the bottom surface side, and the patterned photoresist is formed on the seed layer. Next, the seed layer in the opening portion of the photoresist is removed by wet etching or dry etching. An Ni/Au plating layer may be formed on the remaining seed layer by electroless plating. Although not shown, a second external electrode conductor layer which becomes the second external electrode 122 is provided on the insulating layer 2022 on the bottom surface side.

Here, since the first external electrode conductor layer 2121 is formed to conform to a shape of an upper surface of the insulating layer 2022 on the bottom surface side, an upper surface of the first external electrode conductor layer 2121 has a recess in a region overlapping the hole 2022a. Note that the first external electrode conductor layer 2121 may be formed to have a flat upper surface.

As shown in FIG. 12H, division into individual components is performed along the cutting line C. Consequently, as shown in FIG. 9, the inductor component 1E is manufactured.

### 2. MODIFICATION EXAMPLES

### First Modification Example

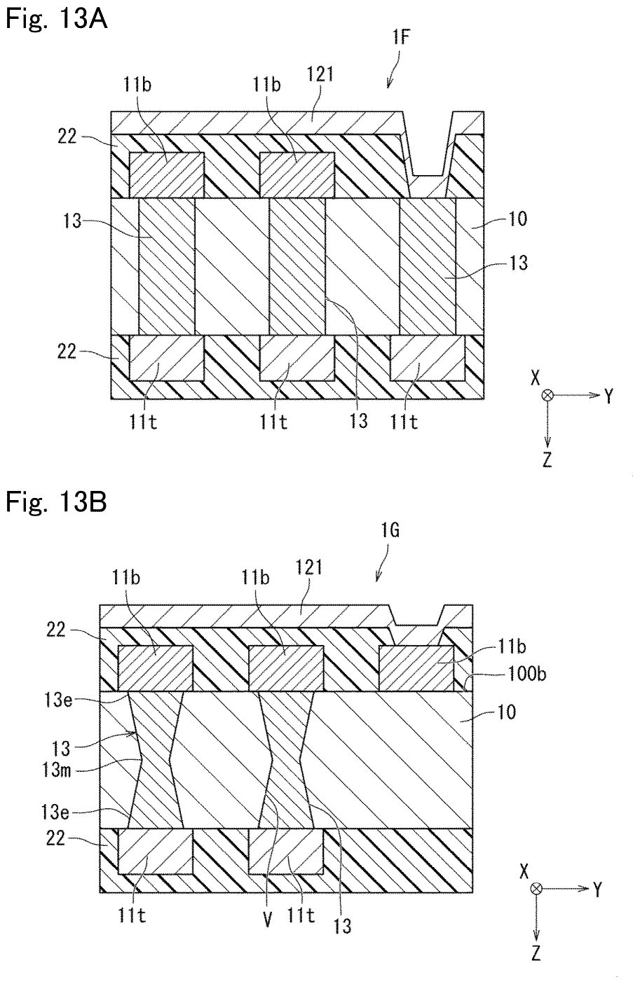

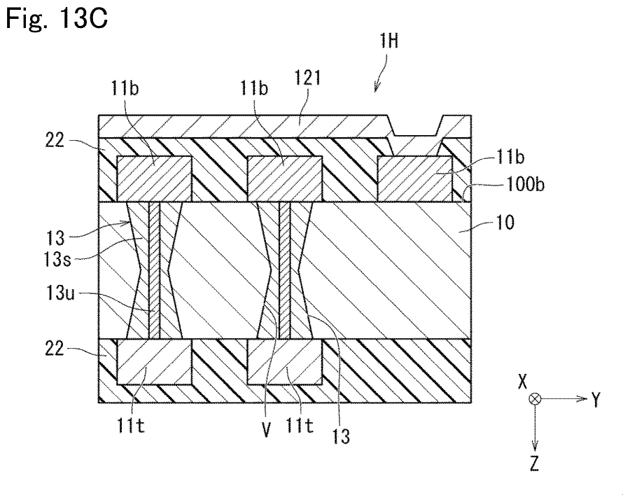

FIG. 13A is a view showing a first modification example of the inductor component, and the view corresponds to the cross section taken along line IX-IX in FIG. 8. As shown in FIG. 13A, in an inductor component 1F of the first modification example, the first external electrode 121 is not connected to the bottom surface wiring 11b but is connected to the first penetration wiring 13. That is, a first end portion of the corresponding first penetration wiring 13 is connected to the first external electrode 121, and a second end portion of the corresponding first penetration wiring 13 is connected to the top surface wiring 11t. This enables the coil to be easily connected to the first external electrode 121 even when the number of turns of the coil is changed. Similarly, the second external electrode 122 may be connected to the second penetration wiring 14, instead of the bottom surface wiring 11b.

### Second Modification Example

FIG. 13B is a view showing a second modification example of the inductor component, and the view corresponds to the cross section taken along line IX-IX in FIG. 8. As shown in FIG. 13B, in an inductor component 1G of the second modification example, the first penetration wiring 13 extends in a direction orthogonal to the bottom surface wiring 11b, and a cross-sectional area of each of both end portions 13e of the first penetration wiring 13 in an extending direction thereof is larger than a cross-sectional area of a central portion 13m of the first penetration wiring 13 in the extending direction. That is, in a cross section of the first penetration wiring 13 in the extending direction, a width of the first penetration wiring 13 in a direction orthogonal to the extending direction continuously increases from the central portion 13m toward both the end portions 13e.

This enables the cross-sectional area of the end portion 13e of the first penetration wiring 13 to be increased, so that the connectivity between the first penetration wiring 13 and at least one of the bottom surface wiring 11b and the top surface wiring 11t can be improved. In addition, when the through-hole V is formed as a hole portion in the element body 10, the through-hole V is filled with a conductive material by fill plating or the like, and the first penetration wiring 13 is formed in the through-hole V, it is easy to fill the through-hole V on an opening side with the conductive material. Since the cross-sectional area of the end portion 13e of the first penetration wiring 13 is large, and the cross-sectional area of the central portion 13m of the first penetration wiring 13 is small, the first penetration wiring 13 is easily formed.

Note that the cross-sectional area of one end portion 13e of the first penetration wiring 13 may be larger than the cross-sectional area of the central portion 13m of the first penetration wiring 13. Similarly, the cross-sectional area of at least one end portion of the second penetration wiring 14 may be larger than the cross-sectional area of the central portion 13m of the first penetration wiring 13.

### Third Modification Example

FIG. 13C is a view showing a third modification example of the inductor component, and the view corresponds to the cross section taken along line IX-IX in FIG. 8. As shown in FIG. 13C, in an inductor component 1H of the third modification example, the first penetration wiring 13 includes a conductive layer 13s positioned on an outer circumferential side thereof when viewed from an extending direction of the first penetration wiring 13, and a non-conductive layer 13u positioned inside the conductive layer 13s. This prevents the Q value from being reduced by providing the conductive layer 13s on the outer circumferential side since a current mainly flows in a surface of the first penetration wiring 13 due to a skin effect in the case of use in a high frequency band. In addition, by providing the non-conductive layer 13u inside, stress can be alleviated, and manufacturing costs can be reduced by using no conductor.

An example of a method of forming the conductor layer 13s and the non-conductive layer 13u will be described. A seed layer is provided on the inner surface of the through-hole V of the element body 10 by sputtering or electroless plating. A plating layer is formed on the seed layer by electrolytic plating. In this manner, for example, a plurality of conductive layers 13s of Ti/Cu/electrolytic Cu, Pd/electroless Cu/electrolytic Cu, or the like can be formed on the first penetration wiring 13 on the outer circumferential side thereof. Thereafter, the inside of the conductive layer 13s is sealed with a resin by printing, hot pressing, or the like to form the non-conductive layer 13u made of a resin. In this manner, stress can be alleviated by the non-conductive layer 13u inside the first penetration wiring 13 while a current flows in the surface (the conductive layer 13s) of the first penetration wiring 13.

Similarly, the second penetration wiring 14 may include a conductive layer positioned on an outer circumferential side thereof when viewed from an extending direction of the second penetration wiring 14, and a non-conductive layer positioned inside the conductive layer.

### Third Embodiment

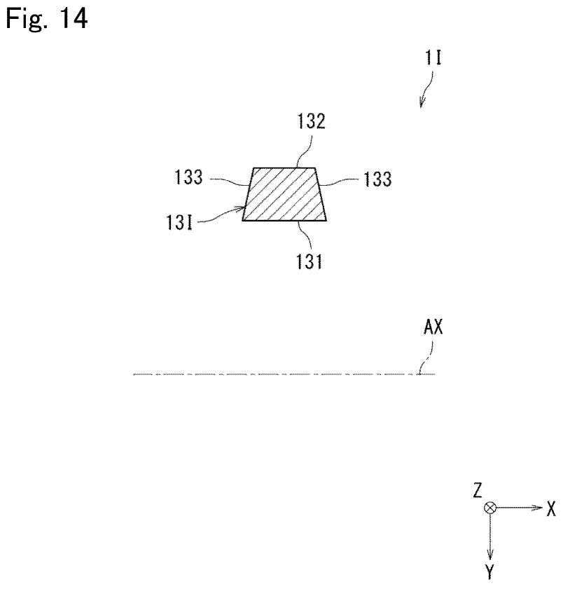

FIG. 14 is an XY cross-sectional view showing a first penetration wiring of a third embodiment of the inductor component. The third embodiment differs from the first embodiment (FIG. 4) in that the inner circumferential edges and the outer circumferential edges of the first penetration wirings are different from those therein, and the different configuration will be described below. The other configurations are the same as those of the first embodiment, and the description thereof will be omitted.

As shown in FIG. 14, in an inductor element 1I of the third embodiment, on a cross section parallel to the bottom surface 100b and including the axis AX, a first penetration wiring 13I has an inner circumferential edge 131 parallel to the axis AX and facing the axis AX side and an outer circumferential edge 132 parallel to the axis AX and facing a side opposite to the axis AX. The length of the inner circumferential edge 131 is longer than the length of the outer circumferential edge 132. Consequently, since a length of the inner circumferential edge 131 is longer than a length of the outer circumferential edge 132, it is possible to increase a surface area of an inner surface of the first penetration wiring 13I. Hence, it is possible to increase the surface area of the inner surface of the coil such that the electrical resistance value at the high frequency is decreased, and the Q value at the high frequency is improved.

The first penetration wiring 13I further includes a side edge 133 that connects the inner circumferential edge 131 and the outer circumferential edge 132 to each other. The side edge 133 is a straight line and is inclined with respect to the direction orthogonal to the axis AX. The side edge 133 faces the side opposite to the axis AX. A space between both the side edges 133 increases from the outer circumferential edge 132 toward the inner circumferential edge 131. That is, the first penetration wiring 13I has a trapezoidal cross-sectional shape. The side edge 133 may have a curved shape instead of a straight line shape.

In addition, although not shown, the second penetration wiring may have the same configuration as that of the first penetration wiring 13I, and has the same operation and effects as those of the first penetration wiring 13I described above.

### Fourth Embodiment

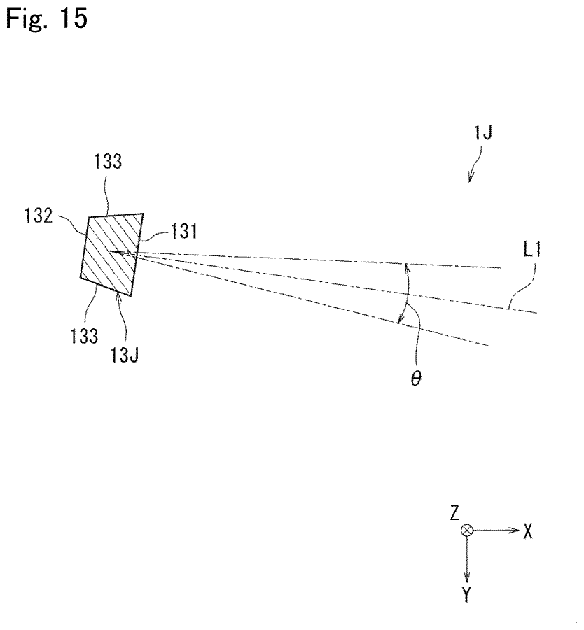

FIG. 15 is an XY cross-sectional view showing a first penetration wiring of a fourth embodiment of the inductor component. The fourth embodiment differs from the second embodiment (FIG. 11) in that the inner circumferential edge and the outer circumferential edge of the reference first penetration wiring are different from those therein, and the different configuration will be described below. The other configurations are the same as those of the second embodiment, and the description thereof will be omitted.

As shown in FIG. 15, in the inductor component 1J according to the fourth embodiment, when the bisector L1 of the angle θ formed by the bottom surface wiring 11b and the top surface wiring 11t connected to a reference first penetration wiring 13J is defined when viewed in the direction orthogonal to the bottom surface 100b, on a cross section parallel to the bottom surface 100b and including the axis AX, a reference first penetration wiring 13A has an inner circumferential edge 131 parallel to a direction orthogonal to the bisector L1 and facing the bisector L1 side, and an outer circumferential edge 132 parallel to the direction orthogonal to the bisector L1 and facing a side opposite to the bisector L1. The length of the inner circumferential edge 131 is longer than the length of the outer circumferential edge 132. Consequently, since a length of the inner circumferential edge 131 is longer than a length of the outer circumferential edge 132, it is possible to increase a surface area of an inner surface of the reference first penetration wiring 13J. Hence, it is possible to increase the surface area of the inner surface of the coil such that the electrical resistance value at the high frequency is decreased, and the Q value at the high frequency is improved.

The reference first penetration wiring 13J further includes a side edge 133 that connects the inner circumferential edge 131 and the outer circumferential edge 132 to each other. The side edge 133 is a straight line and is inclined with respect to the bisector L1. The side edge 133 faces the side opposite to the bisector L1. The space between both the side edges 133 increases from the outer circumferential edge 132 toward the inner circumferential edge 131. That is, the reference first penetration wiring 13J has a trapezoidal cross-sectional shape. The side edge 133 may have a curved shape instead of a straight line shape.

Note that all the first penetration wirings may have the same configuration as that of the reference first penetration wiring 13A. In addition, although not shown, the reference second penetration wiring may have the same configuration as that of the reference first penetration wiring 13J, and has the same operation and effects as those of the first penetration wiring 13J described above. In this case, all the second penetration wirings may have the same configuration as that of the reference second penetration wiring.

Note that the present disclosure is not limited to the embodiments described above, and can be modified in design without departing from the gist of the present disclosure. For example, the individual characteristic points of the first to fourth embodiments may be variously combined.

In the first embodiment and the second embodiment, the first penetration wiring has the inner circumferential edge, the outer circumferential edge, and the side edge, but may include only the inner circumferential edge and the outer circumferential edge without having the side edge. In this case, the inner circumferential edge and the outer circumferential edge may be convex curves, and for example, the curvature radius of the inner circumferential edge is larger than the curvature radius of the outer circumferential edge. In addition, the inner circumferential edge and the outer circumferential edge may be concave curves. In addition, the second penetration wiring may be the same as the first penetration wiring.

The present disclosure includes the following aspects.

<1> An inductor component including an element body having a first principal surface and a second principal surface opposite to each other; a coil that is provided in the element body and is wound in a spiral shape along an axis; and a first external electrode and a second external electrode that are provided on the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order. Also, on a cross section parallel to the first principal surface and including the axis, the first penetration wirings have respective inner circumferential edges facing the axis side and respective outer circumferential edges facing a side opposite to the axis, and the inner circumferential edges have a length longer than a length of the outer circumferential edges.

<2> An inductor component including an element body having a first principal surface and a second principal surface opposite to each other; a coil that is provided in the element body and is wound in a spiral shape along an axis; and a first external electrode and a second external electrode that are provided on the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order. Also, when a bisector of an angle formed by each of the first coil wirings and each of the second coil wirings connected to a reference first penetration wiring that is one of the first penetration wirings is defined when viewed in a direction orthogonal to the first principal surface, on a cross section parallel to the first principal surface and including the axis, the reference first penetration wiring has an inner circumferential edge facing the bisector side and an outer circumferential edge facing a side opposite to the bisector, and the inner circumferential edge has a length longer than a length of the outer circumferential edge.

<3> An inductor component including an element body having a first principal surface and a second principal surface opposite to each other; a coil that is provided in the element body and is wound in a spiral shape along an axis; and a first external electrode and a second external electrode that are provided on the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order. Also, on a cross section parallel to the first principal surface and including the axis, each of the first penetration wirings has an inner circumferential edge which is parallel to the axis and faces the axis side and an outer circumferential edge which is parallel to the axis and faces a side opposite to the axis, and a length of the inner circumferential edge is longer than a length of the outer circumferential edge.

<4> An inductor component including an element body having a first principal surface and a second principal surface opposite to each other; a coil that is provided in the element body and is wound in a spiral shape along an axis; and a first external electrode and a second external electrode that are provided on the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order. Also, when a bisector of an angle formed by each of the first coil wirings and each of the second coil wirings connected to a reference first penetration wiring that is one of the first penetration wirings is defined when viewed in a direction orthogonal to the first principal surface, on a cross section parallel to the first principal surface and including the axis, the reference first penetration wiring has an inner circumferential edge parallel to a direction orthogonal to the bisector and facing the bisector side and an outer circumferential edge parallel to the direction orthogonal to the bisector and facing a side opposite to the bisector, and the inner circumferential edge has a length longer than a length of the outer circumferential edge.

<5> The inductor component according to any one of <1> to <4>, in which the element body contains SiO₂.

<6> The inductor component according to <1> or <2>, in which the inner circumferential edges of the first penetration wirings have respective convex curved portions.

<7> The inductor component according to <6>, in which the plurality of first penetration wirings include two of the first penetration wirings in which orientations of the curved portions of the inner circumferential edges are different from each other.

<8 The inductor component according to any one of <1> to <7>, in which the inner circumferential edges of the first penetration wirings have a length which is 1.5 times or more a length of the outer circumferential edges of the first penetration wirings.

<9> The inductor component according to any one of <1> to <8>, in which, when viewed in the direction orthogonal to the first principal surface, a first end portion of each of the first coil wirings is connected to a first end portion of each of the first penetration wirings, and an outer shape of the coil of the first end portion of each of the first coil wirings conforms to an outer shape of the coil of the first end portion of each of the first penetration wirings.

<10> The inductor component according to any one of <1> to <9>, in which, when viewed in the direction orthogonal to the first principal surface, an angle formed by each of the first coil wirings and each of the second coil wirings connected to the same first penetration wiring is 5° or larger and 45° or smaller (i.e., from 5° to) 45°.

<11> The inductor component according to any one of <1> to <10>, in which, on a cross section orthogonal to an extending direction of the first coil wirings, upper surfaces of the first coil wirings positioned on a side opposite to the axis have a convex shape protruding upward on a side opposite to the axis.

<12> The inductor component according to <11>, in which the first external electrode is disposed on the first coil wirings, and the upper surfaces of the first coil wirings face the first external electrode.

<13> The inductor component according to any one of <1> to <12>, in which, when viewed in a direction parallel to the axis, the first penetration wirings and the second penetration wirings are not parallel to each other.

<14> The inductor component according to any one of <1> to <13>, in which the element body contains SiO₂, and the first penetration wirings contain SiO₂.

<15> The inductor component according to any one of <1> to <14>, in which each of the first penetration wirings has a void portion or a resin portion.

<16> The inductor component according to any one of <1> to <15>, in which each of the first penetration wirings includes a conductive layer positioned on an outer circumferential side when viewed in an extending direction of the first penetration wirings, and a non-conductive layer positioned inside the conductive layer.

<17> The inductor component according to any one of <1> to <16>, in which a length of the coil in an axial direction is shorter than an inner diameter of the coil.

<18> The inductor component according to any one of <1> to <17>, in which the first penetration wirings extend in the direction orthogonal to the first principal surface, and a cross-sectional area of at least one of both end portions of each of the first penetration wirings in the extending direction is larger than a cross-sectional area of a central portion of each of the first penetration wirings in the extending direction.

<19> The inductor component according to any one of <1> to <18>, in which, when viewed in the direction orthogonal to the first principal surface, the first external electrode and the second external electrode are positioned on an inner side with respect to an outer surface of the element body.

<20> The inductor component according to any one of <1> to <19>, further including an organic insulating body provided on the first principal surface, in which the element body is an inorganic insulating body, and the organic insulating body is positioned on an inner side with respect to an outer surface of the inorganic insulating body when viewed in the direction orthogonal to the first principal surface.

What is claimed is:

1. An inductor component comprising:
an element body having a first principal surface and a second principal surface opposite to each other;
a coil that is in the element body and is wound in a spiral shape along an axis; and
a first external electrode and a second external electrode that are on the element body and are electrically connected to the coil, wherein
the axis of the coil is parallel to the first principal surface,
the coil includes
a plurality of first coil wirings which are on the first principal surface side with respect to the axis and are arranged along the axis on a plane parallel to the first principal surface,
a plurality of second coil wirings which are on the second principal surface side with respect to the axis and are arranged along the axis on a plane parallel to the second principal surface,
a plurality of first penetration wirings which extend from the respective first coil wirings toward the respective second coil wirings and are arranged along the axis, and
a plurality of second penetration wirings which extend from the respective first coil wirings toward the respective second coil wirings, are on a side opposite to the respective first penetration wirings with respect to the axis, and are arranged along the axis,
each of the first coil wirings, each of the first penetration wirings, each of the second coil wirings, and each of the second penetration wirings configure at least a part of the spiral shape by being connected in this order, and
on a cross section parallel to the first principal surface and including the axis, the first penetration wirings have respective inner circumferential edges facing the axis side and respective outer circumferential edges facing a side opposite to the axis, and the inner circumferential edges have a length longer than a length of the outer circumferential edges.

2. An inductor component comprising:
an element body having a first principal surface and a second principal surface opposite to each other;
a coil that is in the element body and is wound in a spiral shape along an axis; and
a first external electrode and a second external electrode that are on the element body and are electrically connected to the coil, wherein
the axis of the coil is parallel to the first principal surface,
the coil includes
a plurality of first coil wirings which are on the first principal surface side with respect to the axis and are arranged along the axis on a plane parallel to the first principal surface,
a plurality of second coil wirings which are on the second principal surface side with respect to the axis and are arranged along the axis on a plane parallel to the second principal surface,
a plurality of first penetration wirings which extend from the respective first coil wirings toward the respective second coil wirings and are arranged along the axis, and
a plurality of second penetration wirings which extend from the respective first coil wirings toward the respective second coil wirings, are on a side opposite to the respective first penetration wirings with respect to the axis, and are arranged along the axis,
each of the first coil wirings, each of the first penetration wirings, each of the second coil wirings, and each of the second penetration wirings configure at least a part of the spiral shape by being connected in this order, and
when a bisector of an angle defined by each of the first coil wirings and each of the second coil wirings connected to a reference first penetration wiring that is one of the first penetration wirings is defined when viewed in a direction orthogonal to the first principal surface, on a cross section parallel to the first principal surface and including the axis, the reference first penetration wiring has an inner circumferential edge facing the bisector side and an outer circumferential edge facing a side opposite to the bisector, and the inner circumferential edge has a length longer than a length of the outer circumferential edge.

3. An inductor component comprising:
an element body having a first principal surface and a second principal surface opposite to each other;
a coil that is in the element body and is wound in a spiral shape along an axis; and
a first external electrode and a second external electrode that are on the element body and are electrically connected to the coil, wherein
the axis of the coil is parallel to the first principal surface,
the coil includes
a plurality of first coil wirings which are on the first principal surface side with respect to the axis and are arranged along the axis on a plane parallel to the first principal surface,
a plurality of second coil wirings which are on the second principal surface side with respect to the axis and are arranged along the axis on a plane parallel to the second principal surface,
a plurality of first penetration wirings which extend from the respective first coil wirings toward the respective second coil wirings and are arranged along the axis, and
a plurality of second penetration wirings which extend from the respective first coil wirings toward the respective second coil wirings, are on a side opposite to the respective first penetration wirings with respect to the axis, and are arranged along the axis,
each of the first coil wirings, each of the first penetration wirings, each of the second coil wirings, and each of the second penetration wirings configure at least a part of the spiral shape by being connected in this order, and
on a cross section parallel to the first principal surface and including the axis, each of the first penetration wirings has an inner circumferential edge which is parallel to the axis and faces the axis side and an outer circumferential edge which is parallel to the axis and faces a side opposite to the axis, and a length of the inner circumferential edge is longer than a length of the outer circumferential edge.

4. An inductor component comprising:
an element body having a first principal surface and a second principal surface opposite to each other;
a coil that is in the element body and is wound in a spiral shape along an axis; and
a first external electrode and a second external electrode that are on the element body and are electrically connected to the coil, wherein
the axis of the coil is parallel to the first principal surface,
the coil includes
a plurality of first coil wirings which are on the first principal surface side with respect to the axis and are arranged along the axis on a plane parallel to the first principal surface,
a plurality of second coil wirings which are on the second principal surface side with respect to the axis and are arranged along the axis on a plane parallel to the second principal surface,
a plurality of first penetration wirings which extend from the respective first coil wirings toward the respective second coil wirings and are arranged along the axis, and
a plurality of second penetration wirings which extend from the respective first coil wirings toward the respective second coil wirings, are on a side opposite to the respective first penetration wirings with respect to the axis, and are arranged along the axis,
each of the first coil wirings, each of the first penetration wirings, each of the second coil wirings, and each of the second penetration wirings configure at least a part of the spiral shape by being connected in this order, and
when a bisector of an angle defined by each of the first coil wirings and each of the second coil wirings connected to a reference first penetration wiring that is one of the first penetration wirings is defined when viewed in a direction orthogonal to the first principal surface, on a cross section parallel to the first principal surface and including the axis, the reference first penetration wiring has an inner circumferential edge parallel to a direction orthogonal to the bisector and facing the bisector side and an outer circumferential edge parallel to the direction orthogonal to the bisector and facing a side opposite to the bisector, and the inner circumferential edge has a length longer than a length of the outer circumferential edge.

5. The inductor component according to claim 1, wherein
the element body includes SiO₂.

6. The inductor component according to claim 1, wherein
the inner circumferential edges of the first penetration wirings have respective convex curved portions.

7. The inductor component according to claim 6, wherein
the plurality of first penetration wirings include two of the first penetration wirings in which orientations of the curved portions of the inner circumferential edges are different from each other.

8. The inductor component according to claim 1, wherein
the inner circumferential edges of the first penetration wirings have a length which is 1.5 times or more a length of the outer circumferential edges of the first penetration wirings.

9. The inductor component according to claim 1, wherein
when viewed in the direction orthogonal to the first principal surface, a first end portion of each of the first coil wirings is connected to a first end portion of each of the first penetration wirings, and an outer shape of the coil of the first end portion of each of the first coil wirings conforms to an outer shape of the coil of the first end portion of each of the first penetration wirings.

10. The inductor component according to claim 1, wherein
when viewed in the direction orthogonal to the first principal surface, an angle defined by each of the first coil wirings and each of the second coil wirings connected to the same first penetration wiring is from 5° to 45°.

11. The inductor component according to claim 1, wherein
on a cross section orthogonal to an extending direction of the first coil wirings, upper surfaces of the first coil wirings on a side opposite to the axis have a convex shape protruding upward on a side opposite to the axis.

12. The inductor component according to claim 11, wherein
the first external electrode is on the first coil wirings, and
the upper surfaces of the first coil wirings face the first external electrode.

13. The inductor component according to claim 1, wherein
when viewed in a direction parallel to the axis, the first penetration wirings and the second penetration wirings are not parallel to each other.

14. The inductor component according to claim 1, wherein
the element body includes SiO₂, and
the first penetration wirings includes SiO₂.

15. The inductor component according to claim 1, wherein
each of the first penetration wirings has a void portion or a resin portion.

16. The inductor component according to claim 1, wherein
each of the first penetration wirings includes a conductive layer on an outer circumferential side when viewed in an extending direction of the first penetration wirings, and
a non-conductive layer positioned inside the conductive layer.

17. The inductor component according to claim 1, wherein
a length of the coil in an axial direction is shorter than an inner diameter of the coil.

18. The inductor component according to claim 1, wherein
the first penetration wirings extend in the direction orthogonal to the first principal surface, and
a cross-sectional area of at least one of both end portions of each of the first penetration wirings in the extending direction is larger than a cross-sectional area of a central portion of each of the first penetration wirings in the extending direction.

19. The inductor component according to claim 1, wherein
when viewed in the direction orthogonal to the first principal surface, the first external electrode and the second external electrode are on an inner side with respect to an outer surface of the element body.

20. The inductor component according to claim 1, further comprising:
an organic insulating body on the first principal surface, wherein
the element body is an inorganic insulating body, and the organic insulating body is on an inner side with respect to an outer surface of the inorganic insulating body when viewed in the direction orthogonal to the first principal surface.
